(19) United States
(12) Patent Application Publication
(10) Pub. No.: US 2019/0385105 A1
(43) Pub. Date: Dec. 19, 2019

(54) Latent Ability Model Construction Method, Parameter Calculation Method, and Labor Force Assessment Apparatus

(71) Applicant: Zhejiang University, Hangzhou (CN)

(72) Inventors: Zhiling LUO, Hangzhou (CN); Jianwei YIN, Hangzhou (CN); Xiya LV, Hangzhou (CN); Ying LI, Hangzhou (CN); Shuiguang DENG, Hangzhou (CN); Zhaohui WU, Hangzhou (CN)

(73) Assignee: Zhejiang University

(21) Appl. No.: 16/439,973

(22) Filed: Jun. 13, 2019

(30) Foreign Application Priority Data
Jun. 13, 2018 (CN) 201810609195.8

(51) Int. Cl. G06Q 10/06

(52) U.S. Cl. CPC G06Q 10/06312; G06Q 10/063112

(57) ABSTRACT

Provided is a computer-based latent ability model construction method, a parameter calculation method for characteristic parameters of work ability, and a labor force assessment apparatus based on the latent ability model. The method constructs a latent ability model, and introduces characteristic parameters of work ability into the latent ability model to reveal the internal relations among the employee, the activity, and the service time. The characteristic parameters of work ability is calculated to obtain a final value, and labor force assessment can be carried out according to the final value. The labor force assessment comprises performance prediction, work ability comparison, and employee-activity matching evaluation.

### CROSS-REFERENCE TO RELATED APPLICATIONS

The present application claims the benefit of Chinese Patent Application No. 201810609195.8, filed on Jun. 13, 2018. The above is hereby incorporated by reference.

### TECHNICAL FIELD

The invention relates to the computer field, in particular to a latent ability model construction method, a parameter calculation method, and a labor force assessment apparatus based on the latent ability model.

### BACKGROUND

Workforce analytics is a data-driven statistical learning methodology that applies statistical models and machine learning algorithms to worker-related data logs, enabling enterprise organizations to optimize their talent pools and transform human resource management.

Similar to servers in large scale computer systems, employees are the basic operating units in modern enterprises and organizations. The performance of a computer system is measured universally based on the types of workloads using a set of well-known performance metrics, such as throughput and latency. However, unlike computer systems, predicting the performance of employees based on the activities and tasks they have performed is known to be difficult and yet it is on the top of the wish-list for many enterprise leaders. Example questions include: can we predict how many tasks that one employee can do next month? Can we forecast whether a group of three employees is sufficient for a time-sensitive task? Such employee performance prediction problems are significantly more challenging for several reasons. First, comparing with computer servers, human behavior exhibits a much broader spectrum of uncertainty because human performance is influenced by a wide range of factors, many of which are implicit and hidden variables. Second, the human behavior related to employee's performance and satisfaction is dominated by work-related abilities of individuals, as well as how well employees' provided abilities and task-required abilities are matched in the current employee-activity assignments. Thus, simple statistical metrics, such as throughput and latency of employee-activity task execution time, are not suitable and insufficient to be applied as the core indicators for predicting employee performance.

This workforce analysis problem belongs to the class of prediction problems based on un-supervised learning. Existing methods generally fall into two categories:

(1) Prediction based on unsupervised learning methods: Collaborative Filtering (CF) is the most representative unsupervised learning method. (Advances in collaborative filtering, Recommender systems handbook, Springer, 2015, pp. 77-118). We will further illustrate the utility of the CF method and the hidden problems of using CF for such type of workforce analysis problems. In general, a CF method will predict the service time of an employee on a new activity by summarizing the service time data of all other similar employees on this activity. (Collaborative filtering recommender systems, The adaptive web. Springer, 2007, pp. 291-324). One way to measure the similarity of employees is the pairwise weighted similarity of their performance on the set of common activities. With CF+AVG, one can predict the latent service time by averaging of the weighted sum of similar employees' service time data for this activity.

However, this CF-based prediction formulation is susceptible to influence by data sets, and does not work well in the presence of skewed data distribution. Concretely, if the set of common activities between a pair of employees is significantly smaller compared to the total set of activities performed by these two employees, there is highly skewed data distribution exists in employee-activity relations. Such common-set based similarity measure is inaccurate and ineffective for measuring pairwise similarity of employees with respect to their performance on activities.

Different employees may perform the same activity with varying service times and an employee may perform the same activity with varying service time at different times. This indicates that the service time in the log is a complex feature and its value distribution over its domain exhibits some uncertainty and randomness due to hidden relations between employees and activities. Such latent features contribute to the complexity of predicting employee's service time on new activities. Thus, such highly skewedness and random uncertainty in the employee-activity-service time data set can severely degrade the efficiency and accuracy of the existing methods.

(2) Define performance indicators manually: Existing literature studies such randomness in the inference features (e.g., service time) by manually defining some performance indicators. (Evaluation and pre-allocation of operators with multiple skills: A combined fuzzy ahp and max-min approach, Expert Systems with Applications, vol. 37, no. 3, pp. 2043-2053, 2010). For example, considers the subjective factor, e.g., the diligence of employee, and the objective factor, e.g., the complexity of activity. Such problem is addressed by manually identifying whether an employee satisfies the ability requirement of an activity. For instance, to find out whether an employee is good at communication, one needs to pro-define what the communication ability is and how it is measured and then manually give a score on this ability for each pair of employee and activity. (Optimization of mixed-skill multi-line operator allocation problem, Computers & Industrial Engineering, vol. 53, no. 3, pp. 386-393, 2007). These approaches are clearly subjective and not scalable.

In conclusion, there are three main problems in the existing technical methods of labor analysis: First, existing methods predict service time-related information by summarizing data of all other similar objects. Since they rely on other data, their prediction formulas are susceptible to data sets. Second, the relationship between employees and activities shows uncertainty and randomness, leading to the complexity of predicting employees' service time on new activities, resulting in highly skewed data sets and random uncertainties, affecting the efficiency and uncertainty of existing methods. Existing methods do not work well in skewed distribution data. Thirdly, existing methods define the randomness of data relations by manually defining explicit performance indicators, but the manually defined method makes the judgment basis too subjective and the algorithm is not scalable.

In real life, the objective of workforce analysis is to help enterprises/governments/or any other organization improve employee efficiency by mining employee work logs. The desirable example wish-list includes questions such as (i) are the current employee-activity assignments effective? (ii) where and what can we do to improve the overall organizational efficiency? (iii) which activities need to allocate more skillful employees? (iv) how to compare the performance of different employees and find out the most skillful employees in our organization? However, none of the existing technical methods can extract the work ability of employees from the work log data, nor can they extract the work ability required by specific activities, and thus cannot accurately predict the service time to complete the task. In addition, existing technologies cannot objectively evaluate the work ability of different employees and optimize the allocation of employees from the perspective of employee-activity matching.

### SUMMARY OF THE INVENTION

Aiming at the deficiency of existing technology, the present disclosure provides a latent ability model construction method, a parameter calculation method, a working performance prediction method, a work ability comparison method, an employee-activity matching degree evaluation method and related system and apparatus thereof, and a labor assessment apparatus based on the latent ability model, so as to overcome the gap that the existing technology cannot solve the technical problems.

Predicting the time to complete the activities, comparing the work ability among employees, and evaluating the efficiency of the allocation of activities by worker-related data logs are difficult problems in labor force analysis. None of the existing technical methods can extract the work ability of employees from the work log data, nor can they extract the work ability required by specific activities, and thus cannot accurately predict the service time to complete the task. In addition, existing technologies cannot objectively evaluate the work ability of different employees and optimize the allocation of employees from the perspective of employee-activity matching.

In order to solve the above technical problems, the invention creatively constructs a computer-based latent ability model, and automatically uncover the relationship among employees, activities and service time from the given work log records. In order to enable the computer to complete this work, the invention constructs the characteristic parameters of work ability. Through mining the relationship between the parameters and the relationship between the parameters and the employee, activity and service time, the model of latent ability based on computer is finally constructed. The model reveals the relationship among the employees, the activity and the service time, so as to enable the computer to automatically predict the performance of employees, compare their work ability, and estimate the employee-activity match score. Further, in order to obtain the characteristic parameters of the work ability, the invention provides a calculation method for latent ability model parameters, enabling the computer to automatically calculate the parameters through iterative calculation. According to the final value of the parameters calculated, the invention uses the work performance prediction method to extract the work ability of the employee and the work ability required by specific activities from the work log data of the employee, and then accurately predicts the service time to complete the task. In addition, the invention also uses the work ability comparison method and the employee-activity matching evaluation method to objectively evaluate the work ability of different employees and optimize the allocation of employees from the perspective of employee-activity matching, so as to solve the technical problems as mentioned above.

The first purpose of the invention is to provide a computer-based latent ability model construction method.

The second purpose of the invention is to provide a computer-based parameter calculation method for the latent ability model.

The third purpose of the invention is to provide a computer-based performance prediction method.

The fourth purpose of the invention is to provide a computer-based work ability comparation method.

The fifth purpose of the invention is to provide a computer-based estimation method for employee-activity matching degree.

The sixth purpose of the invention is to provide a computer-based parameter calculation system for the latent ability model.

The seventh purpose of the invention is to provide a computer-based performance prediction apparatus.

The eighth purpose of the invention is to provide a computer-based work ability comparison apparatus.

The ninth purpose of the invention is to provide a computer-based evaluation apparatus for employee-activity matching degree.

The tenth purpose of the invention is to provide a computer-based labor force assessment apparatus.

The beneficial effect of the invention is:

1). By building a latent ability model, the invention obtains an indicator that can represent the relationship between data from the data set, avoiding subjectivity and unscalability, caused by the required manual definitions. The model is robust and much less dependent on the data set. The density change of the data set will not significantly affect the results of the algorithm, and it still performs well in the skewed data set.

2). Based on the above latent ability model, the invention constructs a work performance prediction method and apparatus, which greatly improves the accuracy of prediction compared with the existing method on the prediction of employee-activity-service time, and requires less execution time.

3). Based on the above latent ability model, the invention constructs a work ability comparison method and apparatus, an employee-activity matching degree evaluation method and apparatus, realizes the comparison of employees' abilities, and solves the problem of employees' allocation on activities.

### BRIEF DESCRIPTION OF THE DRAWINGS

FIG. 1 is a flow chart of construction of the latent ability model, calculation of work ability characteristic parameters, and labor force analysis.

FIG. 2 is a schematic diagram of the computer-based latent ability model construction method.

FIG. 3 is a schematic diagram of the computer-based parameters calculation method for the latent ability model.

FIG. 4 is a schematic diagram of the computer-based performance prediction method.

FIG. 5 is a schematic diagram of the computer-based work ability comparison method.

FIG. 6 is a schematic diagram of the computer-based evaluation method for employee-activity matching degree.

FIG. 7 is a schematic diagram of the computer-based parameter calculation system for the latent ability model.

FIG. 8 is a schematic diagram of the computer-based performance prediction apparatus.

FIG. 9 is a schematic diagram of the computer-based work ability comparison apparatus.

FIG. 10 is a schematic diagram of the computer-based evaluation apparatus for employee-activity matching degree.

FIG. 11 is a schematic diagram of the computer-based labor force assessment apparatus.

FIG. 12 is an exemplary diagram of the latent ability model and the labor force assessment.

FIG. 13 is a structural diagram of parameters of the latent ability model.

FIG. 14 is a diagram illustrating comparison results of the log likelihood or execution time on combined datasets using different methods; wherein (a) the log likelihood comparison with varying ability number m; (b) the log likelihood comparison with varying data density: (c) the execution time comparison with varying ability number m; (d) the execution time comparison with varying data density.

FIG. 15 is a diagram illustrating comparison results between the statistical result and the predicted distribution of service time.

FIG. 16 is a diagram illustrating comparation results of the log likelihood of different models with varying ability number m on basis of 4 log datasets.

FIG. 17 is a diagram illustrating results of the log likelihood of different models with varying dataset density.

FIG. 18 is a diagram illustrating execution time comparison with varying m on basis of 4 log datasets.

FIG. 19 is a diagram illustrating execution time comparison with varying dataset density on basis of 4 log datasets.

FIG. 20 is a diagram illustrating performance comparison results among different contexts; wherein (a) execution time of different contexts from dataset BJ (b) log likelihood of different contexts from dataset BJ (c) execution time of different contexts from dataset HZ (d) log likelihood of different contexts from dataset HZ.

FIG. 21 is a diagram illustrating work ability comparison results of employees E0415, E1885 on activity A775, A258 according to one embodiment of the present invention; wherein (a) assessment of the employee's ability; (b) performance of employee E413 and E1885 on activity A775; (c) performance of employee E413 and E1885 on activity A258; (d) assessment of the ability required by activities.

FIG. 22 is a diagram illustrating work ability comparison results of employee E1254, E2426 on activity A941, A27; wherein (a) assessment of the employee's ability; (b) performance of employee E1254 and E2426 on activity A941; (c) performance of employee E1254 and E2426 on activity A27; (d) assessment of the ability required by activities.

FIG. 23 is a diagram illustrating results of employee activity matching score and candidate activity; wherein (a) the grid color graph of matching score on first 40 activities and 40 employees; (b) the candidate activity number variation diagram of E1254, E2426, E1885 and E413 with the growth of threshold δ.

### DETAILED DESCRIPTION OF THE PREFERRED EMBODIMENTS

In the foregoing description, numerous details are set forth to provide an understanding of the subject matter. However, implementations may be practiced without some or all of these details. Other implementations may include modifications and variations from the details discussed above. It is intended that the appended claims cover such modifications and variations.

The present invention provides a construction method for a latent ability model, a parameter calculation method, and a labor force assessment apparatus based on the latent ability model. Said latent ability model presents characteristics with high prediction accuracy, short calculation time, and excellent extensibility in a computer environment, and can be used for more effective analysis of employee's work efficiency, allocation on activities, and assessment of performance.

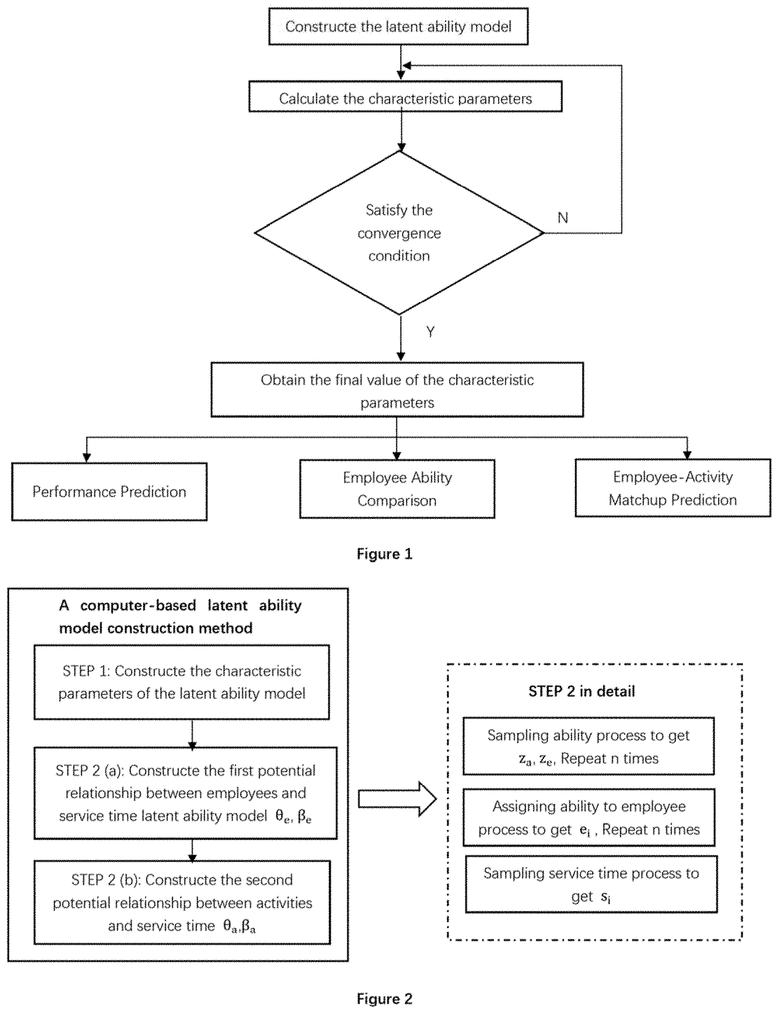

FIG. 1 is a flow diagram showing a computer-based latent ability model construction method, a parameter calculation method of work ability, and a labor force assessment apparatus. First, the latent ability model is constructed, and the characteristic parameters of latent ability model are introduced to reveal the internal relations among employees, activities, and service time. The activities are specific work services, such as approval, examination, report writing, etc. The service time represents the time actually spent by an employee to complete an activity. Secondly, the final value of the characteristic parameter satisfying the convergence condition is obtained through the calculation of the characteristic parameter of work ability. The final value of the characteristic parameters can be used to further predict employees' work performance, compare employees' work ability, and evaluate the matching degree of employees and activities.

In some embodiments, a method of constructing a computer-based latent ability model is provided. In the method, the number of the latent ability variables is m, forming a work ability set B={bᵢ}(1≤j≤m). The construction method comprising the following steps:

(1) Given a work log dataset L, also named as work log dataset, which includes n records, nₐ activities and nₑ employees; each record xᵢ=(aᵢ, eᵢ, sᵢ)(1≤i≤n); wherein aᵢ represents activity number, eᵢ represents the employee number, and sⱼ is the service time for employee eⱼ to complete activity aᵢ; wherein aᵢ, eᵢ, sᵢ are related by the characteristic parameters of the latent ability model: wherein the characteristic parameters of the latent ability model are used to represent the distribution of activity-employee-service time; wherein the characteristic parameters of the latent ability model include θₐ, βₐ, θₑ, βₑ, Cₐ, Cₑ, ω, where θₐ denotes the frequency of work ability required by all the activities in the given work log dataset L, βₐ denotes the probability of the work ability required by one activity, θₑ denotes the frequency of work ability provided by all the employees, βₑ denotes the probability of work ability provided by one employee, Cₐ denotes the complexity of activity. βₑ denotes the complexity of employee, ω denotes ability mismatch penalty.

(2) Build a first latent relationship between employees and service time and a second latent relationship between activities and service time. The first latent relationship is denoted by θₑ, βₑ, and the second latent relationship is denoted by θₐ, βₐ. Wherein, θₐ and βₐ affect the probability of that the activity aⱼ requires work abilities, θₑ and βₑ affect the probability that the employee is able to provide work abilities, θₐ and θₑ affect the probability of the service time sᵢ; the correlation coefficient is denoted by parameters Cₐ, Cₑ, ω, which affect the probability of the service time sᵢ.

The work ability refers to all the work ability of the employee. The work ability includes explicit work ability and implicit work ability. Explicit work ability refers to specific professional business skills exhibited, such as presentation ability of sales staff, document making ability, etc. Implicit work ability includes various qualities of personnel, such as innovation ability, planning ability, coordination ability and so on.

More specifically, the computer-based latent ability model construction method is illustrated in detail in FIG. 2.

Furthermore, in the latent ability model construction method the parameter θₑ is a vector with a length m, and each element θ_{e{i}} in the vector represents the frequency of all employees being able to provide the work ability bᵢ in the given work log dataset L.

In some embodiments, the parameter βₑ is a probability matrix with a size m×nₑ, and each element β_{e{i,j}} in the matrix represents the probability that the work ability bᵢ is assigned to the employee eⱼ in the given work log dataset L.

Preferably, the parameter θₑ conforms to the Dirichlet Distribution θₑ|α˜Dirichlet(α), wherein the parameter α is a given prior distribution.

Preferably, the sum of the elements in each row of the probability matrix βₑ is 1.

In some embodiments, the parameter θₐ is a vector with a length m, and each element θ_{a{i}} in the vector represents the frequency of work ability bᵢ required for all activities in the given work log dataset L.

In some embodiments, the parameter βₐ is a probability matrix with a size m×nₐ, and each element β_{a{i,j}} in the matrix represents the probability that work ability bᵢ is assigned to activity aⱼ in the given work log dataset L.

In some embodiments, the parameter θₐ conforms to the Dirichlet Distribution θₐ|α˜Dirichlet(α), wherein the parameter α is a given prior distribution.

In some embodiments, the sum of the elements in each row of the probability matrix βₐ is 1.

In some embodiments, the parameter Cₐ is a vector with a size nₐ, and each element Cₐ_{ⱼ} in the vector represents the complexity of the activity aⱼ. The higher the service time required to complete the activity, the greater the value of the parameter Cₐ.

In some embodiments, wherein the parameter Cₑ is a vector with a size nₑ, and each element Cₑ_{ⱼ} in the vector represents the complexity of the employee eⱼ. The less service time an employee needs to complete any activity, the greater the value of the parameter Cₑ.

Specifically, an activity has a higher complexity Cₐ than another if it takes more service time no matter which employee performs the activity.

Furthermore, an employee has a higher complexity Cₑ than another, if this employee uses less service time no matter which activity he/she is assigned to.

In some embodiments, the service time sᵢ conforms to the exponential distribution with parameter λ, the probability density function ϕ(sᵢ; λ_{i,j,k})=λ_{i,j,k}exp(−λ_{i,j,k}sᵢ), where

$${λ}_{i , j , k}^{- 1} = \{ \begin{matrix}{C}_{{a}_{j}} {C}_{{e}_{k}} , & if {β}_{a \{ q , j \}} = {β}_{e \{ q , k \}} , ∀ q ∈ \{ 1 , … , m \} \\ {C}_{{a}_{j}} {C}_{{e}_{k}} ω , & otherwise\end{matrix}$$

In some embodiments, the ability mismatch penalty ω is a global parameter contributing to all employees and all activities, representing the amount of penalty for employee-activity ability mismatch. A higher penalty is given if an employee is considered mismatched for an activity if his provided work ability are not matched well to the work ability required by the activity.

In some embodiments, the parameters Cₐ, Cₑ, ω are positive real numbers.

Specifically, the penalty ω is introduced if the employee's provided work is not consistent with the work ability required by the activity. All the service time values in the employee work log fit with the exponential distribution ϕ with the parameters Cₐ, Cₑ and ω. Intuitively, these factors contribute to the relationship between the service time and the employee/activity assignment on ability and thus the distribution of service time values. When the value of work ability required by activities matches that of employees' provided work ability, an exponential distribution is used, the expectation of the exponential distribution being the multiplication of Cₐ and Cₑ, as the distribution of service time. Otherwise, an exponential distribution, the expectation of the exponential distribution being the multiplication of all three parameters: Cₐ, Cₑ, ω.

Refer to FIG. 2, which is a schematic diagram of the computer-based latent ability model construction method. The latent ability model construction method further comprises a step 2, the step 2 comprising an ability sampling process. The ability sampling process refers to select a work ability bᵢ from the work ability set B according to the frequency θₐ, so that the probability of getting the required work ability of an activity is θ_{a{i}}. The result of the ability sampling process is donated by zₐ, formally, zₐ|θₐ˜Discrete(θₐ). The step 2 further comprises a activity-required ability distribution process and an employee-provided ability distribution process.

Combined with FIG. 13, which shows the parameter construction method in the computer-based latent ability model construction method, representing the relationship among parameters, and the relationships between parameters and employees, activities and service time.

In some embodiments, the ability sampling process refers to select a work ability bᵢ from the work ability set B according to the frequency θₑ, so that the probability of getting the provided work ability of an employee is exactly θ_{e{i}}. The result of the ability sampling process is donated by zₑ, formally, zₑ|θₑ˜Discrete(θₑ).

Preferably, the step 2 comprises activity-required ability distribution process. The activity-required ability distribution process refers to assign the required work ability for the activity aᵢ according to the required ability sampling result zₐ and the parameters βₐ, so that a conditional probability of work ability assigned to the activity aᵢ in a given zₐ is exactly equaled to the parameter β_{a{z}_{ₐ}_{}}. The assignment result of the required ability for activities may be expressed aᵢ|zₐ, βₐ˜Discrete(β_{a{z}_{ₐ}_{}}).

Preferably, given the work log dataset L, the activity-required ability distribution process is performed to each log record.

In some embodiments, the step 2 comprises employee-provided ability distribution process. the employee-provided ability distribution process refers to assign the employee eᵢ with a provided ability according to the provided ability sampling result zₑ and the parameter βₑ, so that a conditional probability of work ability assigned to the employee eᵢ in a given zₑ is exactly equaled to the parameter β_{e{z}_{ₑ}_{}}. The assignment result of the provided ability of employees may be expressed as eᵢ|zₑ, βₑ˜Discrete (β_{e{z}_{ₑ}_{}}).

Preferably, given the work log dataset L, the employee-provided ability distribution process is performed to each log record.

In some embodiments, the step 2 further comprises a service time sampling process. The service time sapling process refers to sample the service time according to the parameters zₐ, zₑ, Cₐ, Cₑ, ω, to obtain the result sᵢ. The service time sampling result sᵢ may be represented by sᵢ|zₐ, zₑ, Cₐ, Cₑ, ω˜ϕ(sᵢ;λ_{i,j,k}).

Specifically, m may be a system-defined parameter. A larger m will lead to higher cost of learning. Experiments show that for a given employee-activity work log dataset, one can find a near optimal value of m, which gives stable and high accuracy for the computer-based latent ability model parameter calculation method.

Specifically, the ability set B is neither predefined nor obtained directly from the work log dataset L. Intuitively, given a set of activities, if an employee had higher conditional probability distribution on the ability set required by the activities, then the employee has stronger work ability for the activities. Similarly, the required abilities of an activity may be defined by the conditional probability distribution on the ability set s provided by all the employees who have performed this activity. Naturally, if an employee has a better score on the ability set than that of another employee, then the former employee usually uses less service time to complete the given activity.

Specifically, in order to smooth the frequency variables θₐ, θₑ, the Dirichlet Distribution with parameter α is introduced as the prior distribution. The prior distribution for ability on activity is Q(θₐ;α)=Π^{m}θ_{a{i}}^{α-1}/B(α), and the prior distribution for ability on employee is Q(θₑ; α)=Π^{m}θ_{e{i}}^{α-1}/B(α).

Specifically, both frequency parameters θₐ, θₑ and assignment parameters βₐ, βe are unknown in the beginning. There is a number of ways to assign the initial distribution for the frequency parameters θₐ, θₑ and the assignment parameters βₐ, βₑ. Different initial settings will result in the same final value though they may have different convergence rate. Their final values are obtained through iterative learning.

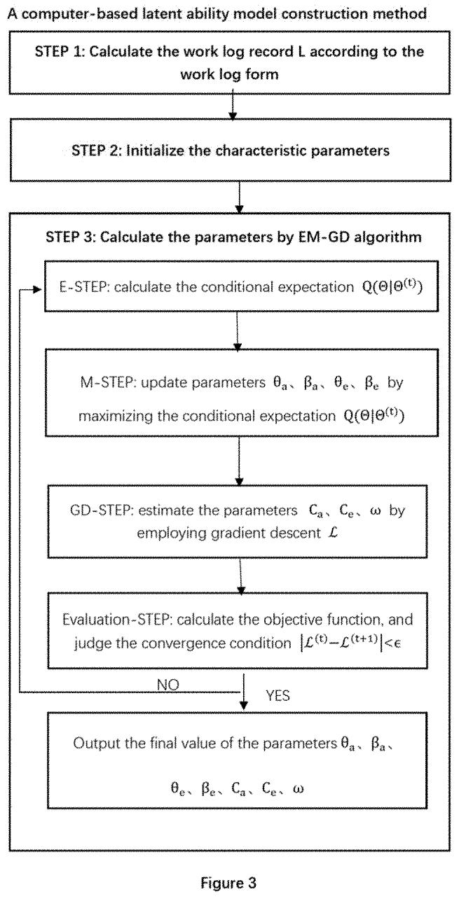

Specifically, the computer-based latent ability model parameter calculation method will be described in detail combined with FIG. 3, Firstly, the work log dataset L was obtained by calculation of a work log record table: and then the characteristic parameters of the work ability were initialized; EM-GD algorithm was used and the steps of E-STEP, M-STEP GD and Evaluation were carried out; and at last the final values of parameters θₐ, βₐ, θₑ, βₑ, Cₐ, Cₑ, ω of the work ability was calculated and output through judging whether the objective function converges or not. Among them, EM refers to EM Algorithm, also known as Expectation Maximization Algorithm.

Another embodiments of the invention provide a computer-based latent ability model parameter calculation method. The method comprising the following steps:

(1) obtaining a work log dataset L by calculation from employee tables, activity table and original work log record table. The employee table include nₑ employees' information: the activity tables include nₐ activities' information; and the original work log record table includes n original records, and each original record includes employee ID, activity ID, start time, end time and so on. The work log dataset L contains n records, nₐ activities, and nₑ employees, wherein each work log record x₁=(aᵢ, eᵢ, sᵢ)(1≤i≤n), where aᵢ is activity ID, eⱼ is employee ID, and sᵢ is the actual service time for employee eᵢ to complete activitie aᵢ;

(2) initializing the characteristic parameters of the work ability, and the characteristic parameters of the work ability include θₐ, βₐ, θₑ, βₑ, Cₐ, Cₑ, ω, wherein θₐ denotes the frequency of work ability required by all the activities in the given work log dataset L, βₐ denotes the probability of work ability required by an activity, θₑ denotes the frequency of work ability provided by all the employees, βₑ denotes the probability of work ability provided by an employees, Cₐ denotes the complexity of activity, Cₑ denotes the complexity of employee and ω denotes ability mismatch penalty. The number of the work ability is m, forming the work ability set B={b₁} (1 [symbol] i [symbol] m).

(3) obtaining the final value of the characteristic parameters of the work ability by calculating the characteristic parameters of the work ability using the EM-GD algorithm. The EM-GD algorithm consists of four steps: E-STEP, M-STEP, GD step, and Evaluation step. The EM-GD algorithm evaluate whether the final value of the characteristic parameters of the work ability could be obtained according to the Evaluation step. If the convergence condition of the Evaluation step is not satisfied, an iterative calculation will be carried out. The iterative calculation comprises the steps of E-STEP, M-STEP, GD step and Evaluation step. If the convergence condition of the Evaluation step is met, the iteration ends and the final value of the characteristic parameters of the work ability is obtained. The final value means that currently obtained latent ability model is the optimal model for simulating the distribution of activity-employee-service time. The E-STEP is used to obtain the expected value. The M-STEP is used to maximize the expected value in E-STEP calculation, and update the parameters θₐ, βₐ, θₑ, βₑ. The GD step uses the gradient descent algorithm to update the parameters Cₐ, Cₑ, ω. The Evaluation step is used to calculate the objective function, update the objective function, and determine if the convergence condition is met, wherein he objective function is used to determine if the convergence condition is met.

In the operation of the EM-GD algorithm in step (3), the first latent relationship and the second latent relationship constructed in the computer-based latent ability model construction method are used in the E-STEP and M-STEP. In the GD step, the service time correlation coefficient built in the computer-based latent ability model construction method is used. In the Evaluation step, the first latent relationship, the second latent relationship and the service time correlation coefficients are used. The first latent relationship is denoted by θₑ, βₑ, the second latent relationship is denoted by θₐ, βₐ. The second latent relationship θₐ sand βₐ affect the probability of work ability required by activity aᵢ; θₑ and βₑ affects the probability of work ability provided by the employee eᵢ; θₐ and θₑ affects the probability of the service time sᵢ; the correlation coefficient which is denoted by parameters Cₐ, Cₑ, ω, affects the probability of the service time sᵢ.

In some embodiments, in the parameter calculation method, the objective function is denoted by [symbol] , and its expression is:

[symbol]

=P(Θ|L)=ZΠᵢ₌₁ⁿΣⱼ₌₁^{m}Σₖ₌₁^{m}τ_{i,j,k}ϕ(sᵢ;λ_{i,j,k})

where P(Θ|L) denotes the posterior probability Θ in the given the work log dataset L; parameter Θ=(θₐ, βₐ, θₑ, βₑ, Cₐ, Cₑ, ω); Z is a constant for normalizing the objective function [symbol] and keeping the sum of all probabilities equal to 1; τ_{i,j,k} represents the probability that activity aⱼ requires work ability bⱼ and employee eᵢ provides work ability bₖ in the i-th record xᵢ=(aⱼ, eⱼ,sⱼ) of the work log dataset L; ϕ(sᵢ; λ_{i,j,k}) denotes the probability density function of service time sᵢ and the service time sᵢ conforms to the exponential distribution with parameter A.

Furthermore, the objective function used to estimate parameters can also use the maximum likelihood estimation (MLE) method.

In some embodiments, in the parameter calculation method, the probability density ϕ(sᵢ; λ_{i,j,k})=λ_{i,j,k}exp(−λ_{i,j,k}sⱼ), where

$${λ}_{i , j , k}^{- 1} = \{ \begin{matrix}{C}_{{a}_{j}} {C}_{{e}_{k}} , & if {β}_{a \{ q , j \}} = {β}_{e \{ q , k \}} , ∀ q ∈ \{ 1 , … , m \} \\ {C}_{{a}_{j}} {C}_{{e}_{k}} ω , & otherwise\end{matrix} .$$

In some embodiments, in the parameter calculation method, the expression of τ_{i,j,k} is as follows:

$${τ}_{i , j , k} = {β}_{a \{ j , i \}} {β}_{e \{ k , i \}} {θ}_{a \{ j \}} {θ}_{e \{ k \}} \frac{1}{B ( a )} {\prod }_{{i}^{′} = 1}^{m} {( {θ}_{a \{ {i}^{′} \}} {θ}_{e \{ {i}^{′} \}} )}^{α - 1} ,$$

where β_{a{j,i}} represents the probability that the work ability bⱼ in the given work log dataset L is assigned to the activity aⱼ; β_{e{k,i}} represents the probability that the work ability bₖ in the given work log dataset L is assigned to the employee eᵢ; θ_{a{j}} denotes the frequency of work ability bⱼ required by all the activities in the given work log dataset L; θ_{e{k}} denotes the frequency of work ability bₖ provided by all the employees in the given work log dataset L; B(α) represents Beta function with parameter α, and α is a pre-specified hyperparameter.

In some embodiments, in the parameter calculation method, the E-STEP in EM-GD algorithm calculates the conditional distribution T_{i,j,k}^{(t)}; of the probability uᵢ and the probability vᵢ by Bayes theorem, given the current estimation of parameters Θ^{(t)}. The probability uᵢ represents the probability of assigning the work ability bⱼ to the activity aᵢ; the probability vᵢ represents the probability of assigning the work ability bₖ to the employee eᵢ. The expression of T_{i,j,k}^{(t)} is as follows:

$$\begin{matrix}{T}_{i , j , k}^{( i )} = P ( {u}_{j} = j , {v}_{i} = k \vert {a}_{i} , {e}_{i} {s}_{i} , {Θ}^{( i )} ) \\ = \frac{{τ}_{i , j , k} φ ( {s}_{i} ; {λ}_{i , j , k} )}{{\sum }_{{j}^{′} = 1}^{m} {\sum }_{{k}^{′} = 1}^{m} {τ}_{i , {j}^{′} , {k}^{′}} φ ( {s}_{i} ; {λ}_{i , {j}^{′} , {k}^{′}} )}\end{matrix}$$

where t is the number of current iteration; P(uᵢ=j, vᵢ=k|aᵢ, eᵢ, sᵢ, Θ^{(t)}) denotes the joint conditional probability that work ability bⱼ is assigned to activity aᵢ and work ability bₖ is assigned to employee eᵢ, given the current estimation of parameters Θ^{(t)} the work record aⱼ, eᵢ, sᵢ; wherein a is activity ID, eᵢ is employee ID, and sᵢ is the actual service time for employeeᵢ to complete activitie a₁.

In some embodiments, in the t-th iteration, according to the conditional probability distribution T_{i,j,k}^{(t)}, calculating the conditional expectation Q(Θ|Θ^{(t)}), the calculation expression is as follows:

$$\begin{matrix}Q ( Θ \vert {Θ}^{( t )} ) = {𝔼}_{U , V \vert L , {Θ}^{( t )}} [ log P ( Θ \vert L , U , V ) \} \\ = {\sum }_{i = 1}^{n} {\sum }_{j = 1}^{m} {\sum }_{k = 1}^{m} {T}_{i , j , k}^{( i )} log ( {τ}_{j , i , k} φ ( {s}_{j} ; {λ}_{i , j , k} ) )\end{matrix}$$

where U={zₐ}ᵢ; V={z_{c}}ᵢ; P(Θ|L, U, V)=ZΠᵢ₌₁ⁿ Σⱼ₌₁^{m}Σₖ₌₁^{m}I(j=uᵢ)I(k=vᵢ)τ_{i,j,k}ϕ(sᵢ;λ_{i,j,k}); Z is a constant for normalizing the conditional probability P and keeping the sum of all conditional probabilities equal to 1; and I(·) represents an indicator function which returns 1 if the input condition is true, and returns 0 otherwise.

In some embodiments, θₐ is constrained by Eⱼ₌₁^{m}θ_{a{j}}=1.

In some embodiments, θ_{c} is constrained by Σⱼ₌₁^{m}θ_{e{j}}=1.

In some embodiments, βₑ is constrained by Σₚ₌₁^{e}^{ₙ} β_{e{k,p}}=1.

In some embodiments, βₐ is constrained by Σₚ₌₁ⁿ^{ₐ}β_{a{k,p}}=1.

In some embodiments, in the M-STEP of EM-GD algorithm, parameters θₐ, βₐ, θₑ, βₑ is updated by maximizing the condition expectation Q(Θ|Θ|Θ^{(t)}).

In some embodiments, the calculation expression for updating the parameter θₐ is as follows:

$$\begin{matrix}{θ}_{a}^{( i + 1 )} = {arg}_{{θ}_{a}} max Q ( Θ \vert {Θ}^{( i )} ) \\ = {arg}_{{θ}_{a}} max {\sum }_{i = 1}^{n} {\sum }_{j = 1}^{m} {\sum }_{k = 1}^{m} {T}_{i , j , k}^{( t )} \\ ( log {θ}_{a \{ j \}} + ( α - 1 ) {\sum }_{{i}^{′} = 1}^{m} log ( {θ}_{a \{ {i}^{′} \}} ) ) .\end{matrix}$$

In some embodiments, the calculation expression for updating every item θ_{a{j}} in parameter θₐ is as follows:

$${θ}_{a \{ j \}}^{( i + 1 )} = \frac{( a - 1 ) n + {\sum }_{i = 1}^{n} {\sum }_{k = 1}^{m} {T}_{i , j , k}^{( i )}}{( m ( α - 1 ) + 1 ) n} .$$

In some embodiments, the calculation expression for updating the parameter θₑ is as follows:

$$\begin{matrix}{θ}_{e}^{( i + 1 )} = {arg}_{{θ}_{e}} max Q ( Θ \vert {Θ}^{( i )} ) \\ = {arg}_{{θ}_{e}} max {\sum }_{i = 1}^{n} {\sum }_{j = 1}^{m} {\sum }_{k = 1}^{m} {T}_{i , j , k}^{( t )} \\ ( log {θ}_{a \{ j \}} + ( α - 1 ) {\sum }_{{i}^{′} = 1}^{m} log ( {θ}_{a \{ {i}^{′} \}} ) ) .\end{matrix}$$

In some embodiments, the calculation expression for updating every item θ_{e{k}} in parameter θₑ is as follows:

$${θ}_{e \{ k \}}^{( i + 1 )} = \frac{( a - 1 ) n + {\sum }_{i = 1}^{n} {\sum }_{k = 1}^{m} {T}_{i , j , k}^{( i )}}{( m ( α - 1 ) + 1 ) n} .$$

In some embodiments, the calculation expression for updating the parameter βₐ is as follows:

βₐ^{(t+1)}=arg_{β}_{ₐ}max Q(Θ|Θ^{(t)}).

In some embodiments, the calculation expression for updating the parameter βₑ is as follows:

βₑ^{(t+1)}=arg_{β}_{ₑ}max Q(Θ|Θ^{(t)}).

In some embodiments, the calculation expression for updating every item β_{a{i,q}} in parameter βₐ is as follows:

$${β}_{a [ i , q ]}^{( t + 1 )} = \frac{{\sum }_{i = 1}^{n} {\sum }_{k = 1}^{m} {T}_{i , j , k}^{( t )} I ( {a}_{i} = q )}{{\sum }_{i = 1}^{n} {\sum }_{j = 1}^{m} {\sum }_{k = 1}^{m} {T}_{i , j , k}^{( t )} I ( {a}_{i} = q )} .$$

In some embodiments, the calculation expression for updating every item β_{e{k,p}} in parameter βₑ is as follows:

$${β}_{e [ k , p ]}^{( t + 1 )} = \frac{{\sum }_{i = 1}^{n} {\sum }_{j = 1}^{m} {T}_{i , j , k}^{( t )} I ( {e}_{i} = p )}{{\sum }_{i = 1}^{n} {\sum }_{j = 1}^{m} {\sum }_{k = 1}^{m} {T}_{i , j , k}^{( t )} I ( {e}_{i} = p )} .$$

In some embodiments, in the GD step of the EM-GD algorithm, the parameters Cₐ, Cₑ and ω are updated by employing gradient descent (GD) algorithm with learning rate γ, which is hyperparameer.

In some embodiments, the calculation expression for the gradient direction of parameter Cₐ is:

$$\frac{\partial ℒ}{\partial {C}_{{a}_{( q )}}} = {\sum }_{i = 1}^{n} {\sum }_{j = 1}^{m} {\sum }_{k = 1}^{m} {T}_{i , j , k}^{( t )} ( - \frac{1}{{C}_{q}} + \frac{{s}_{i}}{{C}_{{e}_{( {e}_{i} )}} {C}_{{a}_{q}}^{2}} ( I ( j = k ) + \frac{1}{m} I ( j \neq k ) ) ) I ( {e}_{i} = q ) .$$

In some embodiments, the calculation expression for the gradient direction of parameter Cₑ is:

$$\frac{\partial ℒ}{\partial {C}_{{e}_{( q )}}} = {\sum }_{i = 1}^{n} {\sum }_{j = 1}^{m} {\sum }_{k = 1}^{m} {T}_{i , j , k}^{( t )} ( - \frac{1}{{d}_{q}} + \frac{{s}_{i}}{{C}_{{a}_{( {a}_{i} )}} {C}_{{e}_{q}}^{2}} ( I ( j = k ) + \frac{1}{m} I ( j \neq k ) ) ) I ( {e}_{i} = q ) .$$

In some embodiments, the calculation expression for the gradient direction of parameter ω is:

$$\frac{\partial ℒ}{\partial ω} = {\sum }_{i = 1}^{n} {\sum }_{j = 1}^{m} {\sum }_{k = 1}^{m} {T}_{i , j , k}^{( t )} ( - \frac{1}{ω} + \frac{{s}_{i}}{{C}_{{a}_{( {a}_{i} )}} {C}_{{e}_{( {e}_{i} )} ω}} ) I ( j \neq k ) .$$

In some embodiments, in the Evaluation step of the EM-GD algorithm, expression of the convergence condition of the objective function [symbol] is | [symbol] ^{(t)}− [symbol] ^{(t+1)}|<ϵ, and ϵ is pre-defined hyperparameter.

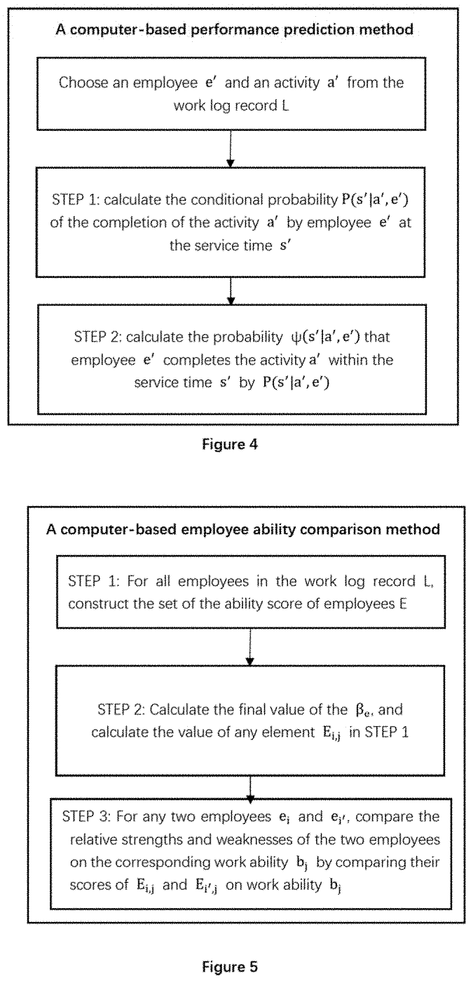

Specifically, a computer-based performance prediction method is illustrated in detail by FIG. 4. For any employee and any activity existing in the work log dataset, the final value of the characteristic parameters of the work ability obtained by the latent ability model of the invention is used to calculate the probability of completing the activity at a certain time point, and then calculate the probability of completing the activity within a certain time period. The obtained probability can be used to predict the service time that the employee completes the activity.

Another embodiments of the invention provide a computer-based performance prediction method. The method comprising:

(1) in the work log dataset L, selecting an employee e′ and an activity a′; obtaining the final values of the characteristic parameters θₐ, βₐ, θₑ, Cₐ, Cₑ, ω of the work ability using the latent ability model parameter calculation method; and calculating the conditional probability P(s′|a′,e′) of the employee e′ completing the activity a′ within the service time s′;

(2) based on the conditional probability P(s′|a′,e′) obtained in step (1), obtaining the probability ψ(s′|a′, e′) that the employee e′ completes the activity a′ within the service time s′, the probability ψ(s′|a′,e′) being used to predict the work performance of employee e′ completing activity a′.

In some embodiments, in the performance prediction method, the final values of the characteristic parameter θₐ, βₐ, θₑ, βₑ, Cₐ, Cₑ, ω and the conditional probability P(s′|a′, e′) satisfy the following expression:

$$P ( s \vert a , e ) = {Z}_{P} {\sum }_{{z}_{a} = 1}^{m} {\sum }_{{z}_{e} = 1}^{m} φ ( s ; {λ}_{i , {z}_{a} , {z}_{e}} ) {β}_{a [ {z}_{a} , a ]} {θ}_{a [ {z}_{a} ]} {β}_{e [ {z}_{e} , e ]} {θ}_{e [ {z}_{e} ]}$$

where Zₚ is a constant for normalizing the conditional probability P(s′|a′,e′) and keeping the sum of all probabilities equal to 1; the probability density function ϕ(sᵢ; λ_{i,j,k})=λ_{i,j,k}exp(−λ_{i,j,k}s′),

$${λ}_{i , j , k}^{- 1} = \{ \begin{matrix}{C}_{{a}_{j}} {C}_{{e}_{k}} , & if {β}_{a [ q , j ]} = {β}_{e [ q , k ]} , ∀ q ∈ \{ 1 , … , m \} \\ {C}_{{a}_{j}} {C}_{{e}_{k} ω ,} & otherwise \end{matrix} .$$

In some embodiments, in the performance prediction method, the calculation expression of Zₚ is:

$$\begin{matrix}{Z}_{p}^{- 1} = {\int }_{0}^{∞} {\sum }_{{z}_{a} = 1}^{m} {\sum }_{{z}_{e} = 1}^{m} φ ( s ; {λ}_{i , {z}_{a} , {z}_{e}} ) {β}_{a [ {z}_{a} , a ]} {θ}_{a [ {z}_{a} ]} {β}_{e [ {z}_{e} , e ]} ds \\ = {\sum }_{{z}_{a} = 1}^{m} {\sum }_{{z}_{e} = 1}^{m} {β}_{a [ {z}_{a} , a ]} {θ}_{a [ {z}_{a} ]} {β}_{e [ {z}_{e} , e ]} {θ}_{e [ {z}_{e} ]} ,\end{matrix}$$

where. β_{a{z}_{ₐ}_{,a′}} represents the probability that the work ability b_{z}_{ₐ} in the given work log dataset L is assigned to the activity aₐ; β_{e{ze,e′}} represents the probability that the work ability b_{z}_{ₑ} in the given work log dataset L is assigned to the employee e_{e′}; θa_{{z}_{ₐ}_{}} denotes the frequency of work ability b_{z}_{ₐ} required by all the activities in the given work log dataset L; θ_{e{z}_{ₑ}_{}} denotes the frequency of work ability b_{z}_{ₑ} provided by all the employees in the given work log dataset L.

In some embodiments, in the performance prediction method, the probability ψ(s′|a′, e′) is obtained by the probability density function P (s|a′, e′), which satisfies the following expression:

$$\begin{matrix}ψ ( {s}^{′} \vert {a}^{′} , {e}^{′} ) = {\int }_{0}^{s} P ( s \vert {a}^{′} , {e}^{′} ) ds \\ = {Z}_{p} {\sum }_{{z}_{a} = 1}^{m} {\sum }_{{z}_{e} = 1}^{m} {β}_{a [ {z}_{a} , a ]} {θ}_{a [ {z}_{a} ]} {β}_{e [ {z}_{e} , {e}^{′} ]} {θ}_{e [ {z}_{e} ]} ( 1 - exp ( - {λ}_{i , {z}_{a} , {z}_{e}} {s}^{′} ) )\end{matrix}$$

where, β_{a{}_{ₐ}_{,a}} represents the probability that the work ability b_{z}_{ₐ} in the given work log dataset L is assigned to the activity aₐ; β_{e{z}_{ₐ}_{,e′}} represents the probability that the work ability b_{z}_{ₑ} in the given work log dataset L is assigned to the employee e_{e′}; θ_{a{z}_{ₐ}_{}} denotes the frequency of work ability b_{z}_{ₐ} required by all the activities in the given work log dataset L; θ_{e{z}_{ₑ}_{}} denotes the frequency of work ability b_{z}_{ₑ} provided by all the employees in the given work log dataset L.

In some embodiments, the service time is a continuous value, and ψ(s′|a′,e′) represents the probability that employee e′ complete activity a′ within s′ seconds.

In some embodiments, Zₚ is a constant for normalizing conditional probability P(s′|a′,e′) and keeping the sum of all probabilities equal to 1.

In some embodiments, A computer-based work ability comparison method is illustrated by FIG. 5. Build a work ability score set for all employees in the work log dataset. The final values of the characteristic parameters of the work ability obtained in the latent ability model is used to calculate the score of employees on different ability dimensions. For any two employees, their ability score sets may be compared to find out the strengths and weaknesses of their ability.

Another embodiments of the invention provide a computer-based work ability comparison method. The method comprising:

(1) for all employees in the work log dataset L, constructing an ability score set E for employees is constructed. Any element E_{i,j} of the ability score set is used to represent the ability score of employee eᵢ with provided ability bⱼ. The number of the work ability is m, forming a work ability setB={bᵢ} (l [symbol] i [symbol] m).

(2) based on the final value of the βₑ in the characteristic parameter of the work ability obtained in the latent ability model parameter calculation method, calculating and the value of any element E_{i,j} in step (1).

(3) for any two employees eᵢ and e_{i′}, comparing their ability scores E_{i,j} and E_{i′,j} on ability bⱼ to obtain their strengths and weaknesses on the corresponding work ability bⱼ.

In some embodiments, the value of element E_{i,j} is obtained by calculating the final value of the parameter βₑ, which satisfies the following expression:

$${E}_{i , j} = \frac{{β}_{e [ j , i ]}}{max ( {β}_{e [ j ]} )} ,$$

where, β_{e{j,i}} is one element of βₑ, representing the probability of employee eᵢ with provided work ability bⱼ; β_{e{j}} is the j-th row of αₑ; max(β_{e{j}}) is the maximum value for probability of all employees on ability bⱼ; βₑ represents the probability that one employee being able to provide the work ability.

In some embodiments, in the work ability comparison method, there may be two possible results to obtain the work ability score E_{i,j} of employee e_{i′} and the work ability score E_{i′,j} of employee e_{i′} by calculation on any work ability bⱼ, j∈{1, . . . , m}. One is the obtained work ability scores E_{i,j}>E_{i′,j} for any ∀bⱼ∈B, j∈{1, . . . , m}, which means that employee e_{i′} has better work ability score than employee e_{i′} in all activities. In the other case, work ability bⱼ and bₖ exist, which satisfy E_{i,j}>E_{i′,j} and E_{i,k}<E_{i′,k}, meaning that employee e_{i′} has better work ability score than employee eᵢ on at least one work ability.

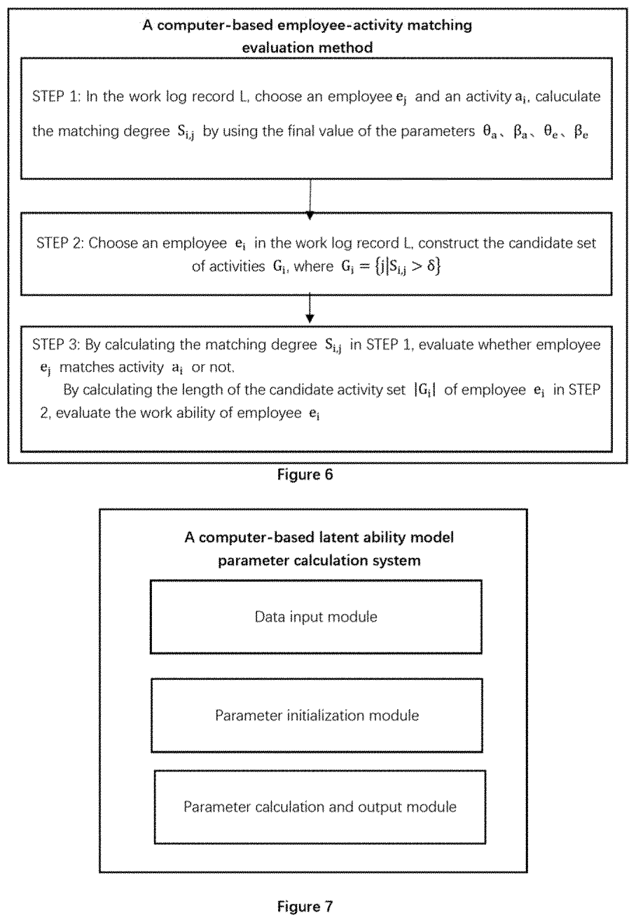

In some embodiments, accompanying with FIG. 6, a computer-based employee-activity matching evaluation method is illustrated in detail. For any pair of employee-activity combinations in the work log dataset, the final values of the characteristic parameters of the work ability obtained in the latent ability model is used to calculate the matching degree of employee-activity. For any employee, the matching degree on all activities can be calculated and obtained, and the activities that exceed a certain threshold can be screened out; the screened-out activities may be used as a candidate activity set. The candidate activity set represents that the employee performs well in the activities contained in the set and those employees can be deemed as qualified.

Another embodiments of the invention provide a computer-based employee-activity matching evaluation method. The method comprising:

(1) in the work log dataset L, selecting an employee eⱼ and an activity aᵢ, the matching degree S_{i,j} of employee eⱼ and activity aᵢ is defined as the probability that employee eⱼ has all the work abilities required for activity aᵢ. The final value of the characteristic parameters θₐ, βₐ, θₑ, βₑ, is obtained by using the latent ability model parameter calculation method. The matching degree S_{i,j} is obtained by calculating the following expressions:

S_{i,j}=Σ_{z}^{m}P(z|i)P(z|i)=Σ_{z}^{m}β_{a{z,i}}β_{e{z,i}}θ_{a{z}}θ_{e{z}};

(2) selecting an employee eᵢ in the work log dataset L. and building the candidate activity set Gᵢ; each element in the candidate activity set represents an activity, and the matching degree S_{i,j} of the employee eᵢ and any activity aⱼ in Gᵢ is greater than a constraint constants δ, meeting the following expressions:

Gᵢ={j|S_{i,j}>δ}, wherein δ is constrained constant;

(3) evaluating whether employeeⱼ matches activity aᵢ or not by calculating the matching degree S_{i,j} in step (1); the greater the matching degree S_{i,j} is, the higher the matching degree of employee eⱼ and activity aᵢ is. By calculating the length |Gᵢ| of the candidate activity set Gᵢ, the ability of employee eᵢ can be evaluated. The greater the length |Gᵢ| is, the more activities that the employee eᵢ can do.

More specifically, accompanying with FIG. 7, a computer-based latent ability model parameter calculation system is illustrated.

Another embodiments of the invention provide a computer-based latent ability model parameter calculation system. The system comprises a data input module, a parameter initialization module, a parameter calculation, and an output module.

The data input module configured to calculate the work log dataset L from employee table, activity table and original work log record table. The employee table includes nₑ employees' information; the activity table includes nₐ activities' information; the original work log record table includes n original records, and each record includes employee ID, activity ID, start time, end time and so on. The work log dataset L contains n records, nₐ activities and nₑ employees, and each work log record xᵢ=(aᵢ,eᵢ, sᵢ)(1≤i≤n), where aⱼ is activity ID, eᵢ is employee ID, and sᵢ is the actual service time for employee eᵢto complete activitie aᵢ.

The parameter initialization module is configured to initialize the characteristic parameters of the work ability, and the characteristic parameters of the work ability include θₐ, βₐ, θ_{c}, βₑ, Cₐ, Cₑ, ω, where wherein θₐ denotes the frequency of work ability required by all the activities in the given work log dataset L, P, denotes the probability of work ability required by an activity, θₑ denotes the frequency of work ability provided by all the employees, β_{c} denotes the probability of work ability provided by an employees, Cₐ denotes the complexity of activity, Cₑ denotes the complexity of employee, and ω denotes ability mismatch penalty. The number of the work ability is m, forming the work ability set B={bᵢ} (1 [symbol] i [symbol] m).

The parameter calculation and output module are configured used to calculate the final values of the characteristic parameters of the latent ability model and output the final values.

In some embodiment, the parameter calculation and output module calculate the final values of the characteristic parameters of the latent ability model and output the final values using the EM-GD algorithm.

The EM-GD algorithm consists of four steps: E-STEP, M-STEP, GD step, and Evaluation step. The EM-GD algorithm evaluate whether the final value of the characteristic parameters of the work ability could be obtained according to the Evaluation step. If the convergence condition of the Evaluation step is not satisfied, an iterative calculation will be carried out. The iterative calculation comprises the steps of E-STEP, M-STEP, GD step and Evaluation step. If the convergence condition of the Evaluation step is met, the iteration ends and the final value of the characteristic parameters of the work ability is obtained. The final value means that currently obtained latent ability model is the optimal model for simulating the distribution of activity-employee-service time. The E-STEP is used to obtain the expected value. The M-STEP is used to maximize the expected value in E-STEP calculation, and update the parameters θₐ, βₐ, θₑ, βₑ. The GD step uses the gradient descent algorithm to update the parameters Cₐ, Cₑ, ω. The Evaluation step is used to calculate the objective function, update the objective function, and determine if the convergence condition is met, wherein he objective function is used to determine if the convergence condition is met.

In some embodiments, in the operation of the EM-GD algorithm, the first latent relationship and the second latent relationship constructed in the computer-based latent ability model construction method are used in the E-STEP and M-STEP. In the GD step, the service time correlation coefficient built in the computer-based latent ability model construction method is used. In the Evaluation step, the first latent relationship, the second latent relationship and the service time correlation coefficients are used. The first latent relationship is denoted by θₑ, βₑ, the second latent relationship is denoted by θₐ, β_{a′}. The second latent relationship θₐ and βₐ affect the probability of work ability required by activity aᵢ; θₑ and βₑ affects the probability of work ability provided by the employee eᵢ; θₐ and θₑ affects the probability of the service time sᵢ; the correlation coefficient which is denoted by parameters Cₐ, Cₑ, ω, affects the probability of the service time sᵢ.

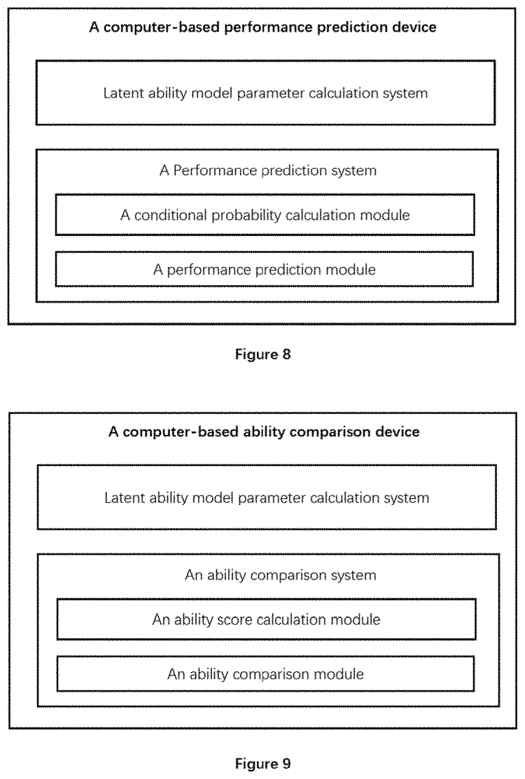

More specifically, accompanying with FIG. 8, a computer-based performance prediction apparatus is illustrated.

Another embodiments of the invention provide a computer-based performance prediction apparatus. The apparatus comprises a latent ability model parameter calculation system and a performance prediction system. The computer-based latent ability model parameter calculation system is configured to calculate and obtain the final values of characteristic parameters θₐ, βₐ, θₑ, βₑ, Cₐ, Cₑ, ω of the work ability; the performance prediction system is used to calculate the probability that an employee completes an activity within a given service time, which is used to predict the performance of an employee in an activity.

In some embodiments, the performance prediction system includes a conditional probability calculation module and a performance prediction module. The conditional probability calculation module uses the final values of the characteristic parameters θₐ, βₐ, θₑ, βₑ, Cₐ, Cₑ, ω to calculate the conditional probability P(s′|a′, e′) of employee c completing activity a within service time s′, wherein the Employee e′ is one selected from the work log dataset L, and activity a′ is one selected from the work log dataset L. The performance prediction module uses the conditional probability P(s′|a′, e′) obtained by the conditional probability calculation module to calculate the probability ψ(s′|a′,e′) that the employee c completes the activity a′ within the service time s′. wherein the probability ψ(s′|a′,e′) is used to predict the work performance of employee e′ in the completion of activity a′.

More specifically, accompanying with FIG. 9, a computer-based ability comparison apparatus is illustrated.

Another embodiments of the invention provide a computer-based ability comparison apparatus. The ability comparison apparatus comprises a latent ability model parameter calculation system and an ability comparison system. The latent ability model parameter calculation system is used to calculate and obtain the final value of characteristic parameters θₐ, βₐ, θₑ, βₑ, Cₐ, Cₑ, ω of the work ability. The ability comparison system is used to calculate the scores of different employees on the same ability, and therefore learn about the strengths and weaknesses of employees on the same ability by comparing the scores.

In some embodiments, the ability comparison system includes an ability score calculation module and an ability comparison module. The ability score calculation module uses the final value of the parameter βₑ in the characteristic parameters to calculate the ability score set E of employees. Any element E_{i,j} in the ability score set E is used to represent the ability score of the employee eᵢ on the ability bⱼ. The number of the work ability is m, forming the work ability set B={bᵢ} (1 [symbol] i [symbol] m); For any two employees eᵢ and e_{i′}, the relative strengths and weaknesses of the two employees on the same work ability bⱼ were learned by comparing their scores E_{i,j} and E_{i′,j} on ability bⱼ.

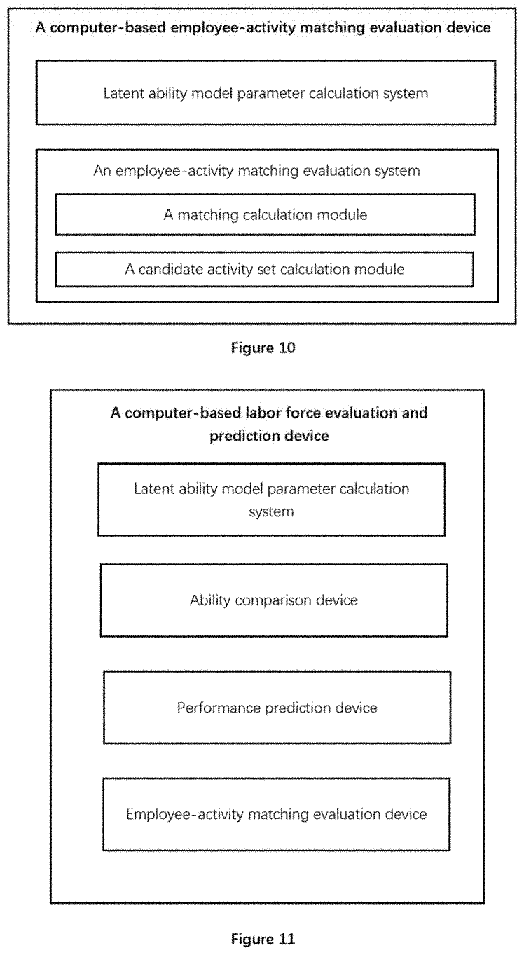

More specifically, accompanying with FIG. 10, a computer-based employee-activity matching evaluation apparatus is illustrated.

Another embodiments of the invention provide a computer-based employee-activity matching evaluation apparatus. The employee-activity matching evaluation apparatus comprises a parameter calculation system and an employee-activity matching evaluation system. The parameter calculation system is used to calculate and obtain the final value of work ability characteristic parameters θₐ, βₐ, θₑ, βₑ, Cₐ, Cₑ, ω. The employee-activity matching evaluation system is used to calculate the matching degree of employee and activity, and obtain the candidate activity set that any of the employees can be qualified.

In some embodiments, the employee-activity matching evaluation system includes a matching calculation module and a candidate activity set calculation module. The matching calculation module uses the final value of the characteristic parameters θₐ, βₐ, θₑ, βₑ, to calculate the matching degree S between employees and activities. The candidate activity set calculation module sets a constraint parameter δ and obtains the candidate activity set by comparing the matching degree S with the constraint constant δ.

More specifically, accompanying with FIG. 11, a computer-based labor force assessment apparatus is illustrated.

Another embodiments of the invention provide a computer-based labor force assessment apparatus. The labor force assessment apparatus comprises one or more of the computer-based latent ability model parameter calculation system, the computer-based performance prediction apparatus, the computer-based ability comparison apparatus, and the computer-based employee-activity matching evaluation apparatus.

Additionally, one embodiment of the invention is provided to specify the realization of the labor assessment prediction apparatus based on the latent ability model in the computer environment, and multiple datasets are used to verify the effect of this realization.

The datasets, consisted of 8 work log datasets, are collected from an operational workflow system deployed by the municipal government of Hangzhou City in China. This workflow system was deployed in seven district government departments and one central department, i.e. ShangCheng (SC), XiaCheng (XC), XiHu (XH), Gongzhu (GS), BinJiang (BJ), ZhiJiang (ZJ) and HangZhou Central (HZ). Log from May. 2013 to April 2015 was collected, amounting to a total of 5,287,621 records. The log involves 1725 employees, and 742 activities. The log collection is carried out from the department of Land Examination and Approval of all the eight departments.

Table 1 shows the statistics of the employee log dataset. In all experiments, the whole log dataset is divided into a training set and a testing set with a ratio 7:3. and ensuring that the pairs of employee and activity in the testing set not appear in the training se. All experiments are conducted on Mac OS X EI Capitan with 16 GB 1 g67 MHz DDR3 memory and 3.1 GHz Intel Core i7. The embodiments implement all algorithms in MATLAB 2015b.

TABLE 1
The Employee-Activity logs

| (a) Raw Employee-Activity log data | | | | | | | (b) Employee-Activity service time table | | |
|---|---|---|---|---|---|---|---|---|---|
| RecordID | ActivityID | EmployeeID | StartTime | | CompleteTime | | ActivityID | EmployeeID | ServiceTime(s) |
| R0001 | A0001 | E0001 | 2014 Sep. 10 | 15:10:33 | 2014 Sep. 10 | 15:13:34 | A0001 | E0001 | 181 |
| R0002 | A0001 | E0001 | 2014 Sep. 10 | 15:21:10 | 2014 Sep. 10 | 15:34:33 | A0001 | E0001 | 803 |
| R0003 | A0001 | E0001 | 2014 Sep. 10 | 15:40:12 | 2014 Sep. 10 | 15:43:22 | A0001 | E0001 | 190 |
| R0004 | A0001 | E0002 | 2014 Sep. 10 | 15:50:01 | 2014 Sep. 10 | 15:54:51 | A0001 | E0002 | 290 |
| R0005 | A0001 | E0002 | 2014 Sep. 10 | 16:01:03 | 2014 Sep. 10 | 16:04:23 | A0001 | E0002 | 260 |
| R0006 | A0001 | E0002 | 2014 Sep. 10 | 16:12:33 | 2014 Sep. 10 | 16:15:33 | A0001 | E0002 | 240 |
| R0007 | A0002 | E0001 | 2014 Sep. 10 | 16:16:10 | 2014 Sep. 10 | 16:23:20 | A0002 | E0001 | 430 |
| R0008 | A0002 | E0001 | 2014 Sep. 10 | 16:25:12 | 2014 Sep. 10 | 16:32:02 | A0002 | E0001 | 410 |
| R0009 | A0002 | E0001 | 2014 Sep. 10 | 16:32:27 | 2014 Sep. 10 | 16:39:07 | A0002 | E0001 | 400 |
| R0010 | A0003 | E0001 | 2014 Sep. 10 | 17:03:45 | 2014 Sep. 10 | 17:09:27 | A0003 | E0003 | 342 |
| R0011 | A0003 | E0002 | 2014 Sep. 10 | 17:10:06 | 2014 Sep. 10 | 17:15:18 | A0003 | E0003 | 312 |
| R0012 | A0003 | E0001 | 2014 Sep. 10 | 17:16:20 | 2014 Sep. 10 | 17:19:44 | A0003 | E0002 | 204 |
| R0013 | A0003 | E0003 | 2014 Sep. 10 | 17:20:20 | 2014 Sep. 10 | 17:23:41 | A0003 | E0002 | 201 |

Table 2 is an exemplary context information sample fragment of employees and activities.

TABLE 2
The sample fragment of context information about employees and activities

| (a) Activity table | | | (b) Employee table | | | |
|---|---|---|---|---|---|---|
| ActivityID | Name | Business | EmployeeID | Name | Gender | Birthday |
| A0001 | Application Checking | Real Estate Transaction | E0001 | C. Zhou | Female | 1985 Aug. 9 |
| A0002 | Advanced Review | Real Estate Transaction | E0002 | P. Wu | Male | 1965 Dec. 10 |
| A0003 | Preliminary Review | Real Estate Transaction | E0003 | J. Wang | Male | 1989 Sep. 23 |
| A0004 | Application Checking | Land Leasing | E0004 | D. Chen | Female | 1990 Jan. 3 |

Table 3 shows seven district government datasets and a central department dataset.

TABLE 3
Seven district government datasets and a central department dataset

| | ShangCheng | XiaCheng | XiHu | GongShu | JiangGan | BinJiang | ZhiJiang | HangZhou |
|---|---|---|---|---|---|---|---|---|
| | District | District | District | District | District | District | District | Central |
| | (SC) | (XC) | (XH) | (GS) | (JG) | (BJ) | (ZJ) | (HZ) |
| # of Activity | 75 | 5 | 92 | 80 | 5 | 175 | 155 | 155 |
| # of Employee | 51 | 45 | 312 | 91 | 44 | 456 | 435 | 291 |
| # of Records | 4641 | 741 | 535570 | 5375 | 720 | 1728413 | 1378838 | 1633323 |
| # of Emp per Act | 1, 6.8, 20 | 2, 14.0, 26 | 1, 14.8, 172 | 1, 7.2, 26 | 1, 14.1, 26 | 1, 25.0, 177 | 1, 26.9, 259 | 1, 28.2, 177 |
| (Min, Avg, Max) | | | | | | | | |
| # of Act per Emp | 1, 9.6, 45 | 1, 1.6, 4 | 1, 4.2, 52 | 1, 6.1, 45 | 1, 1.5, 5 | 1, 9.1, 57 | 1, 8.5, 40 | 1, 14.4, 53 |
| (Min, Avg, Max) | | | | | | | | |
| # of Records per Pair of | 1.26 | 3.37 | 19.29 | 0.77 | 3.27 | 2207 | 22.96 | 37.67 |
| Act and Emp | | | | | | | | |
| Percentage of Recorded | 1.96% | 2.22% | 0.32% | 1.10% | 2.27% | 0.22% | 0.23% | 0.34% |
| Act and Emp Pair | | | | | | | | |

To evaluate the efficiency of the latent ability model in the present invention in terms of prediction accuracy and efficiency, in some embodiments, the latent ability model is compared with three existing representative models based on Latent Dirichlet Allocation (LDA) and Collaborative Filtering (CF). LDA is chosen in the present embodiment because both LDA and latent ability model (LAM) use a generative statistical model. LDA creates a separate feature spaces for each observation variable and explains each type of observations by a set of unobserved features (quantity groups), so as to capture the latent structure of the similar data. CF is used in the present invention because it is the most popular method to mine the correlations between two sets of entities.

The first model is (LDA+GLM), which fits LDA on the observations of activities and employees separately with the same number of ability groups, and then fits the service time observations with a generalized linear model. The second model is (LDA+SVR), which puts LDA on the log data first, and then uses RBF kernel to support vector regression. The third model is known as (AVG+CF), which pre-processes the raw work log data into the service time matrix, with employee and activity as rows and columns, and the average service time as the element value of a given employee and an activity, and uses the collaborative filtering (CF) to predict the unknown service time. The fourth model is the latent ability model as described in the present invention.

Use the log likelihood to measure the accuracy/quality of prediction, which is defined by

L_{g}=Σᵢ₌₁ log(P(sᵢ|aᵢ,eᵢ,(θₐ, βₐ , θ_{c}, βₑ, Cₐ, Cₑ, ω)),

wherein [symbol] aᵢ, eⱼ, sᵢ [symbol] is a record in the testing set. The final values of the above parameters may be calculated by calculating the parameters of the computer-based latent ability model.

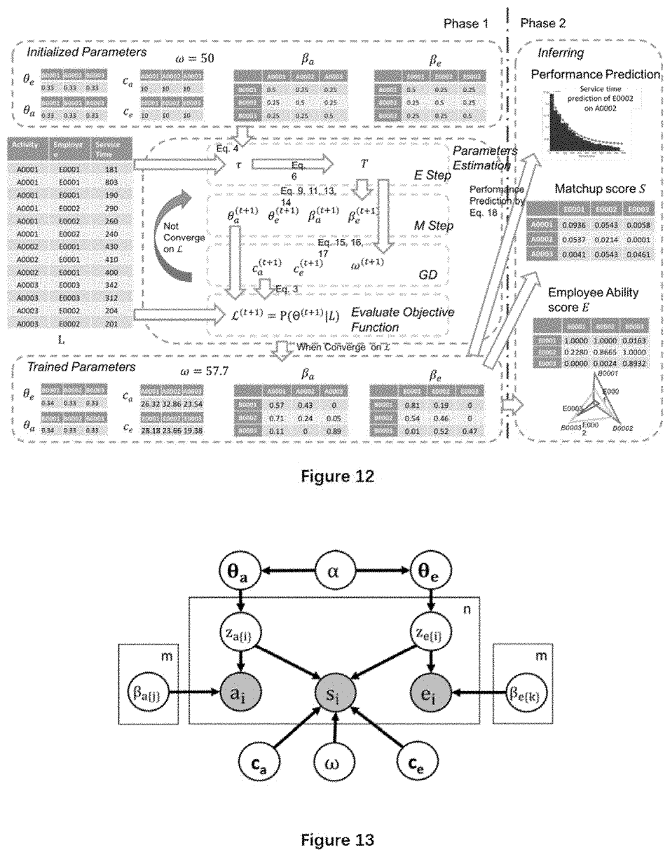

Given an employee-activity pair aᵢ, eⱼ, the probability distribution of the latent ability model outputting the service time sᵢ is shown in the upper right corner of FIG. 12. The prediction result is using LDA+SVR, LDA+GLM and AVG-CF model to predict the service time sᵢ. In order to facilitating the comparison, exponential distribution whose expectation is the predicted service time sᵢ is used as the output distribution of LDA+SVR, LDA+GLM and AVG+CF respectively.

The Dirichlet parameter α is set to 5.0 for all the four models. The higher probability given by any one of the models to the unobserved employee-activity pair, the better the model mines the correlation among the employee, activity, service time, and the work ability. The calculation value of the log likelihood and the execution time of the algorithm are used to measure and compare the accuracy and efficiency of the four models. The higher the log likelihood is, the higher accuracy and efficiency of the model is. The unobserved one means the one never appears.

At first, the accuracy and efficiency of the four models of Evaluating and comparing on employee performance prediction. Wherein the six work record log datasets are collected in combination, and then each one of the six work record log datasets are compared.

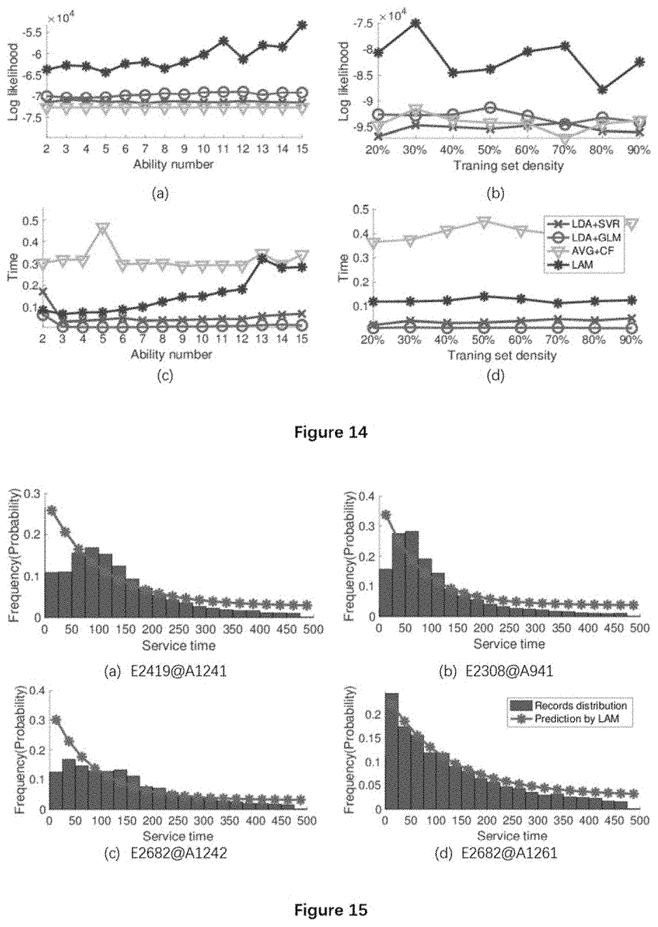

FIG. 14 shows the comparison results of different models on the combined datasets. Apparently, the latent ability model is better than the other three algorithms in quality. In order to vary the density of the training set, some data in the testing dataset is removed to make the testing data sparse. Concretely, the training set density x % refers to that (1−x %) of training dataset was randomly removed. When the density of the training dataset is varied, the default setting m=7 is used. When m is varied, the default density setting 100% is used. More specifically, m represents the number of work ability.

FIGS. 14 (a) and (b) show the log-likelihood of all four models by varying m and the density of the training set respectively. In both cases, LAM exhibits significantly better log-likelihood performance than the other three models. LDA+GLM model is slightly better than LDA+SVR model and AVG+CF model.

FIGS. 14 (c) and (d) show the execution time comparison by varying m and the density of the training set respectively. In both cases, LAM outperforms AVG+CF model with the shortest time. LDA+GLM model is faster than other models but exhibits worse quality. It is also observed that LAM slows down in calculation efficiency when m reaches 13 or more. Accordingly, it is preferred that m=7.

By comparing the distribution of the actual service time in the work log record and the prediction of the latent ability model on the four employee-activity pairs, the high accuracy of LAM prediction performance is further illustrated. FIG. 15 shows the results. It accordingly could be observed that the probability distribution of the service time predicted by LAM is closely approximates the actual distribution in the original work log record. E2419@A1241, E2309@A941, E2682@A1242, E2682@A1261 represent the four employee-activity pairs respectively.

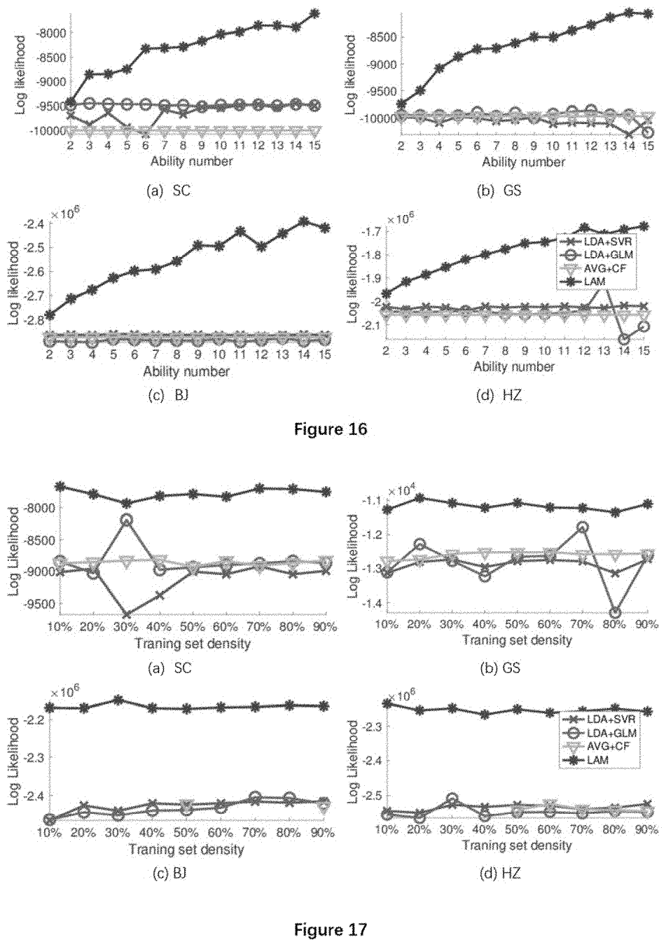

In some embodiments, the accuracy and efficiency of the four models are compared based on six independent datasets, i.e, the work record log datasets from the six departments SC, XH, GS, BJ, ZJ, and HZ. In FIG. 16, m is varied to measure the log likelihood. It can be observed that:

(1) with the increasing of m, all the six work log datasets of LAM have the highest log likelihood;

(2) LDA+SVR, LDA+GLM and AVG+CF have a similar log likelihood independent from m; and

(3) the log likelihood of LAM increases with m.

Given that a greater m requires more time spent in the training phase, m may be set to have both accuracy and efficiency. When m is about 7 or 8, all six datasets exhibit a stable log likelihood. Accordingly, the default setting of m is 7.

The log likelihood on the six datasets may be measured by changing the density percentage of the training dataset. FIG. 17 shows comparison results of log likelihood of different models. It can be observed that LAM consistently delivers high accuracy even when the density of the training dataset is as low as 10%. The performance of LAM is insensitive to the data density, meaning that the latent ability model will not face the cold-start challenge. Additionally, it can be observed that in the big dataset, BJ and HZ, in FIG. 17(c) and FIG. 17(d), the accuracy of LAM is far better than other models.

One reason that the other three models perform poorly for BJ and HZ datasets is the low ratio of their recorded employee-activity pairs in the log over all possible pairs. The ration of employee-activity pairs in the BJ and ZJ datasets is (0.23%). which is the smallest one in all the datasets. Such low ratio shows the severe sparsity existed in the work log dataset, resulting to the worse log likelihood of LDA+SVR, LDA+GLM, AVG+CF to the LAM.

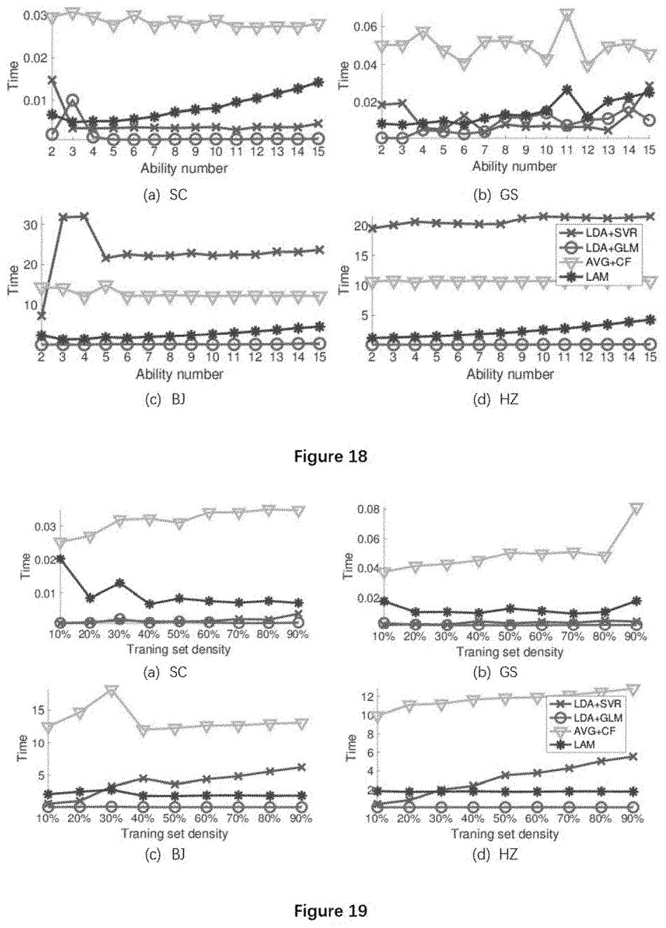

FIG. 18 shows that the execution time of all the four models on the six work log datasets are measured by varying m. In the small datasets. SC and GS, in FIG. 18(a) and FIG. 18(b), LDA+SVR and LDA+GLM take the least execution time. In the big datasets, BJ and HZ, in FIG. (c) and FIG. (d), LAM is much faster than LDA+SVR. FIG. 19 shows the running time with varying training set density. LAM and AVG+CF have the shortest execution time for big datasets, e.g. BJ and HZ, when the dataset density is 30% or higher.

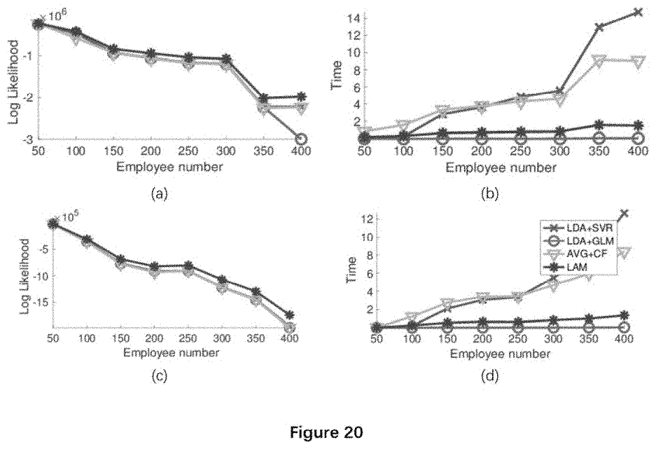

Finally, the execution time and accuracy on different contexts are measured. Two biggest datasets, BJ and HZ, are used in this experiment. The original dataset is removed by involving only a few employee ID. For example, a 100-employee context of BJ means 100 employees from BJ are randomly extracted. Also, the reserved activities are those participated by the randomly selected 100 employees. The training set and the testing set are randomly divided with a ratio 7:3. The experimental results are shown in FIG. 20. In FIG. (a) and FIG. (c), it is observed that the execution time of all models is increasing as the context size (number of employees per context) increases. This is because the larger context means more data records to be processed. In FIG. (b) and FIG. (d), it is observed that the accuracy is decreasing for all models as the context size increases. This is because more employees are involved in the training and testing of the model. The accuracy measure L_{g} may be the sum of log likelihood of all records. Regarding the execution time, LAM grows much slower than LDA+SVR and AVG+CF as the context size increases. Even though LDA+GLM shows slightly shorter execution time than LAM as the context size grows, it exhibits worse accuracy than LAM with the data size increases. This experiments further shows that LAM is more effective than the existing models, especially in large and complex contexts.

The accuracy and efficiency of the four models on employees' ability is evaluated and compared. The employees' ability comparison should consider two typical scenarios: (1) An employee has higher scores in all abilities than the other. Thus, for the set of common activities that they both have participated, the former employee should have better performance than the latter for all activities. (2) For any two employees, each of the two has a higher score in at least one of the ability m. In this case, in the set of common activities that they both have participated, there are always one activity that the former employee does better, and another activity that the latter employee performs better.

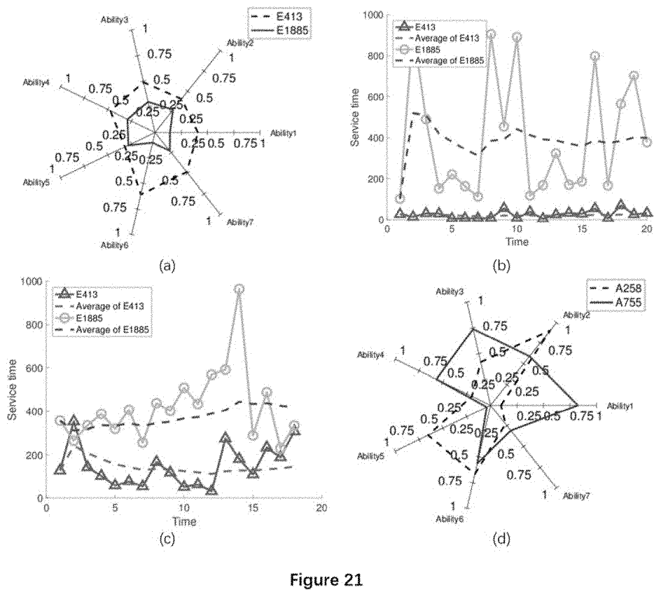

For each employee, the ability scores for all ability m is obtained. In FIG. 21, the efficiency of LAM on the employees' work ability comparison is evaluated by considering the first scenario, e.g., the ability comparison between two employees: E413 and E1885. In FIG. 21(a), given ability number m=7, employee E413 has higher ability score than employee E1885.

In the following, two activities A775 and A258, which are activities that the two employees E413 and E1885 have participated for several times, are extracted from the work log dataset of employees. FIG. 21 (b) illustrates the service time comparison of employees E413 and E1885 on activity A775. It can be observed that employee E413 spent significantly less time and thus is more effective than employee E1885. This result is consistent with the employee ability score comparison in FIG. 21(a). FIG. 21(c) shows the ability comparison of the same pair of employees on activity A258. It again can be observed that employee E413 spent shorter service time than employee E1885, consistent with the fact that employee E413 has higher ability scores than employee E1885 on activity A258. FIG. 21 (d) shows the activity-required ability comparison. It can be observed that activities A775 and A258 have different ability scores when ability number m=7.

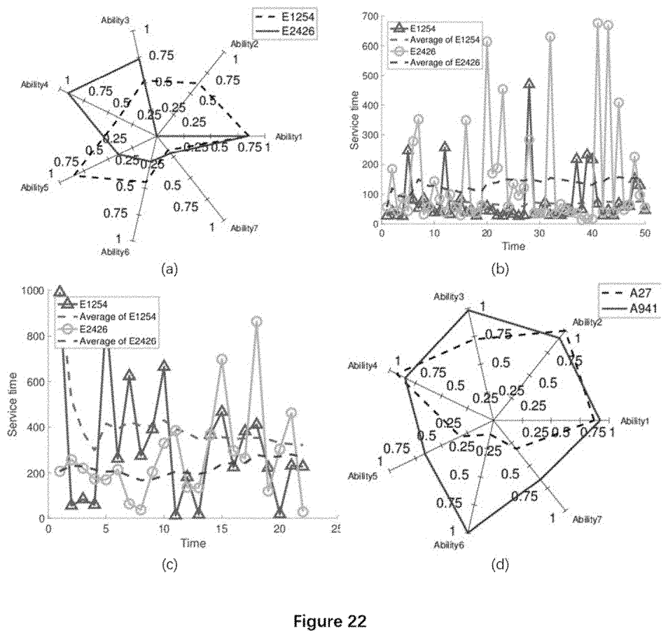

FIG. 22 illustrates the second scenario. From FIG. 22(a), employee E1254 has higher score in ability 2 and ability 5 but lower score in ability 3 and 4, compared with employee E2426. Two activities, A941 and A27, are extracted from the log dataset, which both employees E1254 and E2426 have participated for several times and have different service times. FIG. 22(b) and FIG. (c) show the service time on activity A941 and activity A27 respectively. It can be observed that employee E1254 has shorter service time on activity A941 but longer service time on activity A27, compared with employee E2426. This is consistent with the employee ability scores shown in FIG. 22(a) and the activity-required ability scores shown in FIG. 22(d).

Given an employee-activity pair, predicting the efficiency of the matching of the employee-provided ability and the activity-required ability.

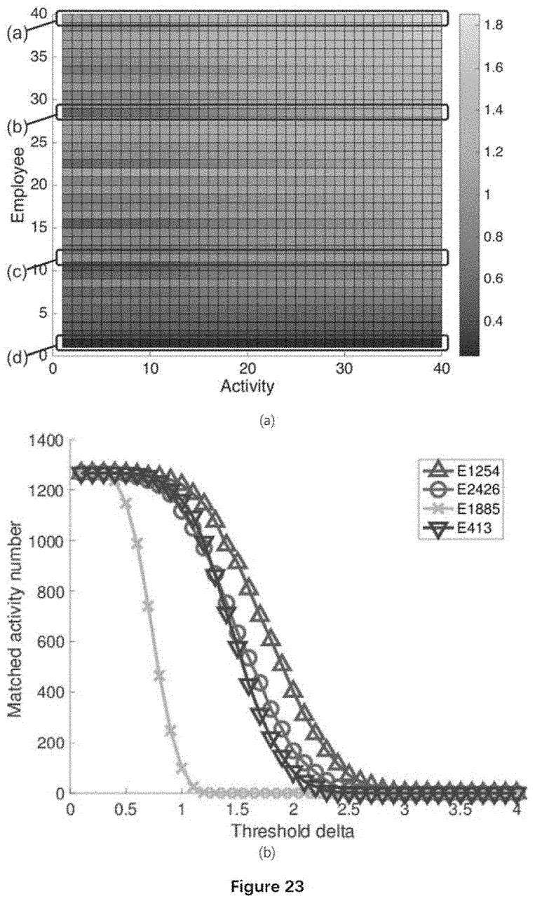

FIG. 23(a) shows the matching score s_{i,j} on the former 40 activities and former 40 employees. The color of the grid represents the matching score, the x-axis represents activity ID, and y-axis represents employee ID. The lighter the color is, the higher matching score is. 40 employees are arranged by their highest provided ability scores on the 40 activities. 40 activities are arranged by the highest required ability score on the 40 employees. It can be observed that the color varies with different activities for most of the employees. Thus, both the employees and the set of activities are sorted such that the right-top portion of FIG. 23(a) is light color and left-bottom portion is dark. This suggests the follows.

First, some employees have either consistently high matching scores on many activities, or have very different matching scores on different activities, such as those marked with (a) and (b) in FIG. 23(a). Specifically, matching scores of employees marked with (a) are varying significantly with respect to the 40 activities. It means that employees marked with (a) are flexible and can work effectively for most of the activities. In comparison, in most activities, the matching scores of employees marked with (b) are lower than those marked with (a). It means that the employees marked with (b) is suitable for only a few activities out of the 40 activities.

Secondly, a few employees have very similar scores on most of the activities, such as employees marked with (c) and employees marked with (d) in FIG. 23(a). The employees marked with (d) have the darkest color, which means lowest matching scores on all 40 activities. This means that employees marked with (d) performs poorly in comparison to the others from the 40 employees.

FIG. 23(b) illustrates the candidate activity group Gᵢ, the candidate activity group Gᵢ is a set of activities having matching score S_{i,j} higher than the threshold δ. Gᵢ is measured by varying the threshold δ, representing the activity number that has matching score higher than the threshold. Four employees: E1254, E2426, E1885 and E413, are used. FIG. 23(b) shows the test results. It can be observed that:

as the threshold δ increases, different employees show different decreasing rate with respect to the size of their candidate activity group. Also, this deceasing rate is tightly related to their ability scores. Recall that employee E1885 has the lowest average score, which is below 0.25, compared to the others, especially employee E413. Thus, the curve of employee E1885 is sharply declined, indicating that the size of his/her candidate activity group reduces the fastest, as the threshold δ increases. The number of candidate activities approaches 0 when the threshold δ is set to 1.5, which implies that no activity is suitable for the employee when the threshold δ≥1.5. In comparison, the other three employees can still matchup much more activities (400 or higher).

Table 4 lists the most appropriate three activities for the four employees. The activities for each employee by the matchup score are ranked and the top-3 activities for each employee are shown. It can be observed that for employee E1254 and E2426, the shortest-time activity hit in the top-3 results. It means that the matchup score is really close to reality. While for employee E413 and E1885, the shortest-time activities do not appear in top-3 results. By checking the data, it can be found that there is no any records about the employees on the top-3 activities. Therefore, these three activities can be recommended to them.

TABLE 4
The Top-3 Activities

| | | | | | | | | Shortest |
|---|---|---|---|---|---|---|---|---|
| | | | | | | | | Service Time |
| EmployeeID | Name | TopActivity1 (ID) | Score | TopActivity2 (ID) | Score | TopActivity3 (ID) | Score | Activity |
| E413 | X. C. | Final Review on | 1.870 | Applying Agreement | 1.868 | Acceptance Checking | 1.861 | A775 |
| | | Affordable Housing | | from Internet (A561) | | (A259) | | |
| | | Department (A621) | | | | | | |
| E1885 | Q. W. | Applying Agreement | 1.637 | Acceptance Checking | 1.637 | Acceptance Checking | 1.625 | A258 |
| | | from Internet (A561) | | (A259) | | on Consulting File | | |
| | | | | | | (A941) | | |
| E1254 | M. Z. | Acceptance on | 1.585 | Acceptance Checking | 1.584 | Applying Agreement | 1.583 | A941 |
| | | Consulting File (A941) | | (A259) | | from Internet (A561) | | |
| E212G | Y. Y. | Acceptance Checking | 1.619 | Applying Agreement | 1.618 | Acceptance Checking | 1.611 | A941 |
| | | (A259) | | from Internet (A561) | | on Consulting File | | |
| | | | | | | (A941) | | |

What is claimed is:

1. A computer-based method for constructing a latent ability model, wherein a number of work ability is m, said m work abilities forming a work ability set B={bᵢ} (1≤i≤m), the method comprising the following steps:
providing a work log dataset L, wherein the work log dataset L includes n work log records, nₐ activities, and nₑ employees; each work log record xⱼ=(aᵢ,eᵢ,sᵢ)(1≤i≤n); wherein aⱼ represents activity ID, eⱼ represents the employee ID, and sⱼ is the service time for the employee eᵢ to complete the activity aᵢ; the activity aᵢ, the employee eᵢ, and the service time sᵢ are related by characteristic parameters of the latent ability model; wherein the characteristic parameters of the latent ability model are configured to represent a distribution of activity-employee-service time; wherein the characteristic parameters of the latent ability model include θₐ, βₐ, θₑ, βₑ, Cₐ, Cₑ, ω, where θₐ denotes the frequency of work ability required by all the activities in the work log dataset L; βₐ denotes the probability of work ability required by one activity, θₑ denotes the frequency of work ability provided by all the employees; βₑ denotes the probability of work ability provided by one employee; Cₐ denotes the complexity of the activity; Cₑ denotes the complexity of the employee; and ω denotes ability mismatch penalty; and
building a first latent relationship between the employees and the service time, and a second latent relationship between the activities and the service time; and building a service time correlation coefficient; wherein the first latent relationship is denoted by θₑ, and βₑ, the second latent relationship is denoted by θₐ, and βₐ; wherein θₐ and βₐ affect the probability of work ability required by the activity aᵢ; θₑ and βₑ affect the probability of work ability provided by the employee eᵢ; θₐ and θₑ affect the probability of the service time sⱼ; the correlation coefficient is denoted by parameters Cₐ, Cₑ, ω, which affect the probability of the service time sⱼ.

2. The method of claim 1, wherein the method further comprises an ability sampling process, in which a work ability bᵢ is selected from the work ability set B according to the frequency θₐ and the frequency θₑ.

3. The method of claim 1, wherein the method further comprises an activity-required ability distribution process configured for assigning the work ability to the activity according to a required ability sampling result zₐ and the parameters βₐ, so that, when the required ability sampling result zₐ is provided, a conditional probability of the work ability assigned to the activity aᵢ equals to the parameter β_{a{z}_{ₐ}_{}}; the activity-required ability distribution result is expressed as: aᵢ|zₐ, βₐ˜Discrete(β_{a{z}_{ₐ}_{}}).

4. The method of claim 1, wherein the method further comprises an employee-provided ability distribution process configured for assigning the work ability to the employee eⱼ according to a provided ability sampling result zₑ and the parameter βₑ, so that, when the provided ability sampling result zₑ is provided, a conditional probability of work ability assigned to the employee eᵢ equals to the parameter β_{a{z}_{ₑ}_{}}; the employee-provided ability distribution result is expressed as: eⱼ|zₑ, βₑ˜Discrete(β_{e{z}_{ₑ}_{}}).

5. The method of claim 1, wherein the method further comprises a service time sampling process; the service time sampling process is configured to sample the service time according to the parameters zₐ, zₑ, Cₐ, Cₑ, ω, to obtain the result sⱼ; the service time sampling result sᵢ is represented by sᵢ|zₐ, zₑ, Cₐ, Cₑ, ω˜ϕ(sⱼ; π_{i,j,k}).

6. A computer-based method for calculating parameters of a latent ability model, the method comprises the following steps:
obtaining a work log dataset L by calculation from an employee table, an activity table, and an original work log record table; wherein the employee table includes nₑ employees' information; the activity table includes nₐ activities' information; and the original work log record table includes n original records; each original record includes an employee ID, an activity ID, a start time, and an end time; the work log dataset L contains n records, nₐ activities, and nₑ employees, wherein each work log record xᵢ=(aⱼ, eⱼ,sⱼ)(1≤i≤n), where aᵢ is the activity ID, eᵢ is the employee ID, and sᵢ is the actual service time for employee eᵢ to complete activitie aᵢ; wherein the service is obtained by the start time and the end time;
initializing the characteristic parameters of the work ability, and the characteristic parameters of the work ability include θₐ, β_{b}, θₑ, βₑ, Cₐ, Cₑ, ω; wherein θₐ denotes the frequency of work ability required by all the activities in the work log record L; βₙ denotes the probability of work ability required by one activity; θₑ denotes the frequency of work ability provided by all the employees; βₑ denotes the probability of work ability provided by one employees; Cₐ denotes the complexity of the activity, Cₑ denotes the complexity of the employee, and ω denotes ability mismatch penalty; the number of the work ability is m, forming a work ability set B={bᵢ} (1 [symbol] i [symbol] m); and
obtaining the final value of the characteristic parameters of the work ability by calculating the characteristic parameters of the work ability using a EM-GD algorithm; the EM-GD algorithm consists of four steps: E-STEP, M-STEP, GD step, and Evaluation step; wherein the EM-GD algorithm evaluates whether final values of the characteristic parameters of the work ability is obtained according to the Evaluation step; if the convergence condition of the Evaluation step is not satisfied, an iterative calculation is carried out; the iterative calculation comprises the steps of E-STEP, M-STEP, GD step and Evaluation step; if the convergence condition of the Evaluation step is met, the iteration ends and the final value of the characteristic parameters of the work ability is obtained; the final value means that currently obtained latent ability model is the optimal model for simulating the distribution of activity-employee-service time; the E-STEP is used to obtain the expected value; the M-STEP is used to maximize the expected value in E-STEP calculation, and update the parameters θₐ, βₐ, θₑ, βₑ; the GD step uses a gradient descent algorithm to update the parameters Cₐ, Cₑ, ω; the Evaluation step is used to calculate the objective function, update the objective function, and determine if the convergence condition is met; wherein the objective function is used to determine if the convergence condition is met.

7. The method of claim 6, wherein the objective function is denoted by [symbol] , and its expression is:
$$ℒ = P ( Θ \vert L ) = Z {\prod }_{i = 1}^{n} {\sum }_{j = 1}^{m} {\sum }_{k = 1}^{m} {τ}_{i , . j , k} φ ( {s}_{i} ; {λ}_{i , j , k} )$$
wherein P(Θ|L) denotes a posterior probability Θ in the work log dataset L; the parameter Θ=(θₐ, βₐ, θₑ, βₑ, Cₐ, Cₑ, ω); Z is a constant for normalizing the objective function [symbol] and keeping the sum of all probabilities equal to 1; τ_{i,j,k} represents the probability that activity aᵢ requires working ability bⱼ and employee eᵢ provides work ability bₖ in the i-th record xⱼ=(aᵢ, eᵢ, sᵢ) of the work log dataset L; ϕ(s; λ_{i,j,k}) denotes the probability density function of service time sᵢ and the service time sᵢ conforms to the exponential distribution with parameter λ.

8. The method of claim 6, wherein the probability density ϕ(sᵢ; λ_{i,j,k})=λ_{i,j,k}exp(−λ_{i,j,k}sᵢ), where
$${λ}_{i , j , k}^{- 1} = \{ \begin{matrix}{C}_{{a}_{j}} {C}_{{e}_{k}} , & if {β}_{a [ q , j ]} = {β}_{e [ q , k ]} , ∀ q ∈ \{ 1 , … , m \} \\ {C}_{{a}_{j}} {C}_{{e}_{k} ω ,} & otherwise \end{matrix} , and \\ {τ}_{i , j , k} = {β}_{a [ i , j ]} {β}_{e [ k , i ]} {θ}_{a [ j ]} {θ}_{e [ k ]} \frac{1}{B ( α )} {\prod }_{{i}^{′} = 1}^{m} {( {Θ}_{a [ i ′ ]} {θ}_{e [ i ′ ]} )}^{α - 1} ,$$
wherein β_{{j,i}} represents the probability that the ability bⱼ in the work log dataset L is assigned to the activity aᵢ; β_{e{k,i}} represents the probability that the ability bₖ in the work log dataset L is assigned to the employee eᵢ; θ_{a{j}} denotes the frequency of work ability bⱼ required by all the activities in the work log dataset L; θe_{{k}} denotes the frequency of work ability bₖ provided by all the employees in the work log dataset L; B(α) represents Beta function with α as parameter, and α is a pre-specified hyperparameter.

9. The method of claim 6, wherein E-STEP in EM-GD algorithm calculates the conditional distribution T_{i,j,k}^{(t)} of the probability uᵢ and the probability vᵢ by Bayes theorem, wherein given the current estimation of parameters Θ^{(t)}; the probability uᵢ represents the probability of assigning the work ability bⱼ to the activity aᵢ; the probability vᵢ represents the probability of assigning the work ability bₖ to the employee eᵢ; the expression of T_{i,j,k}^{(t)} is as follows:
$$\begin{matrix}{T}_{i , j , k}^{( t )} = P ( {u}_{i} = j , {v}_{i} = k \vert {a}_{i} , {e}_{i} , {s}_{i} , {Θ}^{( t )} ) \\ = \frac{{τ}_{i , j , k} φ ( {s}_{i} ; {λ}_{i , j , k} )}{{\sum }_{{j}^{′} = 1}^{m} {\sum }_{{k}^{′} = 1}^{m} {τ}_{i , {j}^{′} , {k}^{′}} φ ( {s}_{i} ; {λ}_{i , {j}^{′} , {k}^{′}} )}\end{matrix}$$
wherein t is the number of current iteration; P(uᵢ=j, vᵢ=k|aⱼ,eⱼ, sⱼ, Θ^{(t)}) denotes the joint conditional probability that work ability bⱼ is assigned to activity aᵢ and work ability bₖ is assigned to employee eⱼ, given the current estimation of parameters Θ^{(t)} the work record aᵢ, eᵢ, sᵢ; wherein aᵢ is activity ID, eᵢ is employee ID, and sᵢ is the actual service time for employeeeⱼ to complete activitie aⱼ;
in the t-th iteration, the conditional expectation Q(Θ|Θ^{(t)}) is calculated according to the conditional probability distribution T_{i,j,k}^{(t)}, the calculation expression is as follows:
$$\begin{matrix}Q ( Θ \vert {Θ}^{( t )} ) = {𝔼}_{U , V \vert L , {Θ}^{( t )}} [ log P ( Θ \vert L , U , V ) ] \\ = {\sum }_{i = 1}^{n} {\sum }_{j = 1}^{m} {\sum }_{k = 1}^{m} {T}_{i , j , k}^{( t )} log ( {τ}_{i , j , k} φ ( {s}_{i} ; {λ}_{i , j , k} ) )\end{matrix}$$
wherein U={zₐ}ᵢ; V={zₑ}ⱼ; P(Θ|L, U, V)=ZΠᵢ₌₁ⁿΣ=ⱼ₌₁^{m}Σₖ₌₁^{m}|I(j=uⱼ)I(k=vᵢ)τ_{i,j,k} ϕ(Sᵢ; λ_{i,j,k}); Z is a constant for normalizing the conditional probability P and keeping the sum of all conditional probabilities equal to 1; and I(·) represents an indicator function which returns 1 if the input condition is true, and returns 0 otherwise.

10. The method of claim 6, wherein the M-STEP in the EM-GD algorithm updates parameters θₐ, βₐ, θₑ, βₑ by maximizing the condition expectation Q(Θ|Θ^{(t)}).

11. The method of claim 6, wherein the GD step in the EM-GD algorithm estimates the parameters Cₐ, Cₑ, and ω by employing the gradient descent (GD) with a learning rate γ, which is set in the latent ability model.

12. The method of claim 6, wherein the Evaluation step in the EM-GD algorithm, expression of the convergence condition of the objective function is [symbol] is | [symbol] ^{(t)}− [symbol] ^{(t+1)}|<∈, and ∈ is a pre-defined hyper-parameter.

13. The method of claim 6, wherein the method is configured used to predict employees' performance by calculating the probability ψ(s′|a′,e′) that the employee e′ completes the activity a′ within the service time s′, which is used to predict a work performance of the employee e′ in completing the activity a′.

14. The method of claim 6, wherein the method is configured to compare employees' abilities by calculating the value E_{i,j}, which satisfies the following expression:
$${E}_{i , j} = \frac{{β}_{e [ j , i ]}}{max ( {β}_{e [ j ]} )}$$
wherein βₑ represents the probability of work ability provided by one employee; β_{e{j,i}} is an element in βₑ, representing the probability of work ability bⱼ provided by the employee eᵢ; β_{e{j}} is the j-th row of βₑ; max(β_{e{j}}) is the max value of probability of work ability bⱼ provided by all employees.

15. The method of claim 6, wherein the method is configured to evaluate the matching degree of employee and activity by calculating the matching degree S_{i,j}, which is obtained by calculating the following expressions: S_{i,j}=Σ_{z}^{m}P(z|i) P(z|j)=Σ_{z}^{m}β_{a{z,i}}β_{e{z,j}}θ_{a{z}}θ_{e{z}}.

16. A computer-based system for calculating parameters of a latent ability model, predicting employees' performance, and comparing employees' abilities; the system comprises a data input module, a parameter initialization module, a parameter calculation module and an output module, wherein:
the data input module configured to calculate the work log dataset L from an employee table, an activity table and an original work log record table; the employee table includes nₑ employees' information; the activity table includes nₐ activities' information; the original work log record table includes n original records, and each record includes employee ID, activity ID, start time, and end time; the work log dataset L contains n records, nₐ activities and nₑ employees, and each work log record xᵢ=(aᵢ, eᵢ, sᵢ)(1≤i≤n), wherein aᵢ is activity ID, eᵢ is employee ID, and sᵢ is the actual service time for employee eᵢ to complete activitie aᵢ. the parameter initialization module is configured to initialize the characteristic parameters of the work ability, and the characteristic parameters of the work ability include θₐ, βₐ, θₑ, βₑ, Cₑ, ω, wherein θₐ denotes the frequency of work ability required by all the activities in the given work log record L, βₐ denotes the probability of work ability required by an activity, θₑ denotes the frequency of work ability provided by all the employees, βₑ denotes the probability of work ability provided by an employees, Cₐ denotes the complexity of activity, Cₑ denotes the complexity of employee, and ω denotes ability mismatch penalty; the number of the work ability is m, forming the work ability set B={bⱼ} (1 [symbol] i [symbol] m);
the parameter calculation module is configured to calculate the final values of the characteristic parameters of the latent ability model.
the output module is configured to output the final values.

17. The system of claim 16, wherein the parameter calculation module is configured to calculate the characteristic parameters of the latent ability and output the final values of the characteristic parameters of the latent ability using the EM-GD algorithm;
the EM-GD algorithm consists of four steps: E-STEP, M-STEP, GD step, and Evaluation step; the EM-GD algorithm evaluate whether the final value of the characteristic parameters of the work ability could be obtained according to the Evaluation step;
if the convergence condition of the Evaluation step is not satisfied, an iterative calculation will be carried out; the iterative calculation comprises the steps of E-STEP, M-STEP, GD step and Evaluation step;
if the convergence condition of the Evaluation step is met, the iteration ends and the final value of the characteristic parameters of the work ability is obtained;
the final value means that currently obtained latent ability model is the optimal model for simulating the distribution of activity-employee-service time;
the E-STEP is used to obtain the expected value;
the M-STEP is used to maximize the expected value in E-STEP calculation, and update the parameters θₐ, βₐ, βₑ, βₑ;
the GD step uses the gradient descent algorithm to update the parameters Cₐ, Cₑ, ω; the Evaluation step is used to calculate the objective function, update the objective function, and determine if the convergence condition is met, wherein the objective function is used to determine if the convergence condition is met.

18. The system of claim 16, wherein the output module further comprises a performance prediction submodule, which is configured to predict the performance of an employee in an activity by calculating the probability that an employee will complete an activity within a given service time.

19. The system of claim 16, wherein the output module further comprises an ability comparison submodule; the ability comparison submodule is configured to calculate the scores of different employees on the same ability, and therefore learn about the strengths and weaknesses of employees on the same ability by comparing the scores.

20. The system of claim 16, wherein the output module further comprises an employee-activity matching evaluation submodule; the employee-activity matching evaluation submodule is configured to calculate a matching of employee and activity and obtain a candidate activity set that all employees is qualified.
